(19) United States
(12) Patent Application Publication
(10) Pub. No.: US 2009/0327918 A1
(43) Pub. Date: Dec. 31, 2009

(54) FORMATTING INFORMATION FOR TRANSMISSION OVER A COMMUNICATION NETWORK

(76) Inventors: Anne Aaron, Menlo Park, CA (US); Siddhartha Annapureddy, Palo Alto, CA (US); Pierpaolo Baccichet, Palo Alto, CA (US); Bernd Girod, Stanford, CA (US); Vivek Gupta, San Jose, CA (US); Iouri Poutivski, Cupertino, CA (US); Uri Raz, Palo Alto, CA (US); Eric Setton, Palo Alto, CA (US)

Correspondence Address: DYNNO INC. C/O WAGNER BLECHER LLP, 123 WESTRIDGE DRIVE, WATSONVILLE, CA, 95076, US

(21) Appl. No.: 12/112,980

(22) Filed: Apr. 30, 2008

Related U.S. Application Data
(60) Provisional application No. 60/915,353, filed on May 1, 2007.

(51) Int. Cl. G06F 3/01; G06F 15/16

(52) U.S. Cl. 715/751; 709/204

(57) ABSTRACT

A method of formatting information for transmission over a peer-to-peer communication network is provided. The method comprises identifying a graphical nature of the information, and capturing the information based on the graphical nature. The method further comprises identifying a graphical content type associated with the information, and encoding the information based on the graphical content type.

### RELATED U.S. APPLICATION

This application claims priority to the copending provisional patent application Ser. No. 60/915,353, Attorney Docket Number DYYNO-001.PRO, entitled “Sharing Applications on the Web with Unified Buddy List,” with filing date May 1, 2007, assigned to the assignee of the present application, and hereby incorporated by reference in its entirety.

### TECHNICAL FIELD

The technology relates to the field of information formatting. In particular, the technology relates to the field of formatting information for transmission over a communication network.

### BACKGROUND

Modern communication systems are generally utilized to route data from a source to a receiver. Such data often includes information content that may be recognized by the receiver, or an application or entity associated therewith, and utilized for a useful purpose. Moreover, a single information source may be used to communicate information to multiple receivers that are communicatively coupled with the source over one or more communication networks. Due to the ability of modern computer systems to process data at a relatively high rate of speed, many modern communication systems utilize one or more computer systems to process information prior to, and/or subsequent to, a transmission of such information, such as at a source of such information, or at a receiver of such a transmission.

### SUMMARY

This Summary is provided to introduce a selection of concepts that are further described below in the Detailed Description. This Summary is not intended to identify key or essential features of the claimed subject matter, nor is it intended to be used as an aid in determining the scope of the claimed subject matter.

A method of formatting information for transmission over a peer-to-peer communication network is provided. The method comprises identifying a graphical nature of the information, and capturing the information based on the graphical nature. The method further comprises identifying a graphical content type associated with the information, and encoding the information based on the graphical content type.

In addition, a method of formatting information for transmission over a peer-to-peer communication network is provided, wherein the method comprises identifying a graphical nature of the information, and capturing the information based on the graphical nature. The method further comprises identifying a graphical content type associated with the information, identifying a data processing load associated with a central processing unit (CPU), and encoding the information based on the graphical content type and the data processing load.

Furthermore, a method of formatting information for transmission over a peer-to-peer communication network is provided, wherein the method comprises identifying a media type associated with the information, and capturing the information based on the media type. The method further comprises identifying a content type associated with the information, identifying a transmission rate that is sustainable over the peer-to-peer communication network, selecting a target rate based on the transmission rate, and encoding the information based on the content type and the target rate.

Moreover, a method of encoding graphical information is provided, wherein the method comprises encoding a portion of the graphical information based on an encoding setting, and packetizing the encoded portion to create a plurality of data packets. The method further comprises receiving feedback indicating a transmission loss of a data packet from among the plurality of data packets, dynamically adjusting the encoding setting in response to the transmission loss, and encoding another portion of the graphical information in accordance with the adjusted encoding setting such that a transmission error-resilience associated with the graphical information is increased.

### DESCRIPTION OF THE DRAWINGS

The accompanying drawings, which are incorporated in and form a part of this specification, illustrate embodiments of the technology for sharing information, and together with the description, serve to explain principles discussed below:

FIG. 1 is a diagram of an exemplary display configuration in accordance with an embodiment.

FIG. 2 is a flowchart of an exemplary method of providing access to information over a communication network in accordance with an embodiment.

FIG. 3 is a block diagram of an exemplary media capture and encoding configuration in accordance with an embodiment.

FIG. 4 is a diagram of an exemplary media encoding configuration in accordance with an embodiment.

FIG. 5 is a diagram of an exemplary data sharing configuration used in accordance with an embodiment.

FIG. 6 is a flowchart of an exemplary method of sharing information associated with a selected application in accordance with an embodiment.

FIG. 7 is a flowchart of a first exemplary method of formatting information for transmission over a peer-to-peer communication network in accordance with an embodiment.

FIG. 8 is a flowchart of a second exemplary method of formatting information for transmission over a peer-to-peer communication network in accordance with an embodiment.

FIG. 9 is a flowchart of a third exemplary method of formatting information for transmission over a peer-to-peer communication network in accordance with an embodiment.

FIG. 10 is a flowchart of an exemplary method of encoding graphical information in accordance with an embodiment.

FIG. 11 is a diagram of a first exemplary data distribution topology in accordance with an embodiment.

FIG. 12 is a diagram of a second exemplary data distribution topology in accordance with an embodiment.

FIG. 13 is a flowchart of an exemplary method of sharing information over a peer-to-peer communication network in accordance with an embodiment.

FIG. 14 is a diagram of an exemplary computer system in accordance with an embodiment.

The drawings referred to in this description are to be understood as not being drawn to scale except if specifically noted.

### DETAILED DESCRIPTION

Reference will now be made in detail to embodiments of the present technology, examples of which are illustrated in the accompanying drawings. While the present technology will be described in conjunction with various embodiments, the present technology is not limited to these embodiments. On the contrary, the present technology is intended to cover alternatives, modifications and equivalents, which may be included within the spirit and scope of the various embodiments as defined by the appended claims.

Furthermore, in the following detailed description, numerous specific details are set forth in order to provide a thorough understanding of the present technology. However, the present technology may be practiced without these specific details. In other instances, well known methods, procedures, components, and circuits have not been described in detail so as not to unnecessarily obscure aspects of the presented embodiments.

### Overview

Modern communication systems are generally utilized to route data from a source to a receiver. Such systems are often server-based, wherein a server receives a data request from a receiver, retrieves the requested data from a data source, and forwards the retrieved data to the receiver. However, due to the economic overhead associated with the purchase of servers, or with paying for throughput or bandwidth provided by such servers, a server-based infrastructure can be costly. Indeed, such an infrastructure may be especially costly when a relatively significant amount of throughput or bandwidth is utilized when transmitting high quality multimedia streams.

In an embodiment, a method of sharing information is presented such that a user is provided the option of sharing specific information with a variable number of other users, in real time. For example, an application is displayed in a display window, or full screen version, within a GUI. Next, a user selects a number of entities with which the user would like to share (1) a view of the displayed content and/or (2) audio content associated with the displayed application. Once receivers associated with these entities are identified, communication is established with each of these receivers over a communication network. Additionally, information associated with the displayed application is captured and then encoded as a media stream, and this stream is forwarded to the group of receivers using a peer-to-peer streaming protocol wherein one or more of such receivers are used as real-time relays.

Once the shared information is received at a receiver, the information is utilized to generate a graphical impression of a view of the application, such as the view of such application as it is displayed in the aforementioned GUI. To illustrate, an example provide that either a window version or full screen version is presented in a GUI at a data source. This same view of the application is then shared with a set of receivers over a peer-to-peer network.

Pursuant to one embodiment, the encoding of the media stream may be adapted to various elements so as to increase the efficiency of the data communication and preserve the real time nature of the transmission. For example, the stream may be encoded based on the type of data content to be shared, the resources of the data source, and/or the available throughput associated with a particular data path over the peer-to-peer network. Moreover, the encoding of the shared content may be dynamically adjusted over time so as to account for such factors as lost data packets or a decrease in available communication bandwidth associated with the network.

Furthermore, in an embodiment, the encoding of the shared content is carried out using advanced media encoders that specialize in the type of content to be encoded. In addition, the encoding settings of these encoders are adapted on the fly so as to optimize the quality of the data stream based on the available communication resources. After the information has been encoded, the encoded content is packetized, and the data packets are forwarded to receivers directly, without the use of a costly server infrastructure. Moreover, a peer-to-peer streaming protocol is implemented wherein the forwarding capabilities of these receivers are utilized to forward the data packets to other receivers. In this manner, an efficient data distribution topology is realized wherein the forwarding capabilities of both the data source and one or more other receivers are simultaneously used to route content within the peer-to-peer network.

Therefore, an embodiment provides a means of sharing information in real time with a scalable number of other users, at low cost, and with high quality. In particular, a multimedia data stream is encoded such that the information associated with an application that is currently displayed at a data source may be shared with multiple receivers in real time, and with an acceptable output quality, without requiring a cumbersome infrastructure setup.

Reference will now be made to exemplary embodiments of the present technology. However, while the present technology is described in conjunction with various embodiments discussed herein, the present technology is not limited to these embodiments. Rather, the present technology is intended to cover alternatives, modifications and equivalents of the presented embodiments.

### Data and Receiver Selection

Prior to sharing data between a data source and a receiver, an embodiment provides that communication is established between the source and the receiver such that a means exists for routing information between the two entities. For example, a data source establishes a sharing session during which specific information may be shared. In addition, a receiver is selected by the data source as a potential candidate with which the data source may share such information. The data source then generates an invitation, wherein the invitation communicates an offer to join the established sharing session, and routes the invitation to the receiver. In this manner, an offer is made to share specific information during a sharing session such that both entities agree to the sharing of such information.

Once the data source and the receiver both agree to engage in a communication of the aforementioned information, an embodiment provides that the information is provided to the receiver by the data source, such as over a communication network with which both the source and the receiver are communicatively coupled. Such an implementation protects against unauthorized access to the information, and guards the receiver against unauthorized exposure to unknown data.

In one embodiment, the data source is communicatively coupled with multiple receivers, and the data source maintains, or is provided access to, a data distribution topology that discloses the destinations to which the information originating at the data source is being routed. In this manner, a hierarchical view of a sharing network is achieved that details the paths through which particular information is routed upon leaving the data source. The data source may then use this data distribution topology to reconfigure a particular data path in response to a more efficient path being recognized.

The foregoing notwithstanding, various means of establishing communication between a data source and a receiver may be implemented. Consider the example where a data source maintains a list of various receivers, wherein network addresses associated with such receivers are accessible to the data source. A user selects one or more of such receivers from the list, and the data source attempts to establish communication with each of the selected receivers.

Pursuant to one embodiment, the user is also provided with the option of specifying which information may be shared with the selected receivers. In particular, the user selects the graphical content and/or the audio content as information to be encoded during a sharing session. Once encoded, the information to be shared is then made accessible to the receivers that have joined the sharing session.

Moreover, in an embodiment, the user is provided with the option of selecting multiple receivers with which to share information, as well as the option of determining whether each of such receivers is to receive the same or different information. Consider the example where multiple content windows are presented in a GUI, wherein each content window displays different information. The user selects a first receiver with which to share information associated with specific content displayed in one of the content windows, and further selects a second receiver with which to share different information associated with content displayed in another window.

Thus, an embodiment provides that multiple receivers are selected, and the same or different information is shared with each of such receivers depending on which content is selected. Pursuant to one embodiment, information is shared with multiple receivers during a same time period. For example, multiple sharing sessions are established such that portions of the temporal durations of these sessions overlap during a same time period, and such that information is shared with the receivers corresponding to these sessions during such time period. Thus, the present technology is not limited to the existence of a single sharing session at a current moment in time. Rather, multiple sharing sessions may exist simultaneously such that multiple data streams may be routed to different destinations during a given time period.

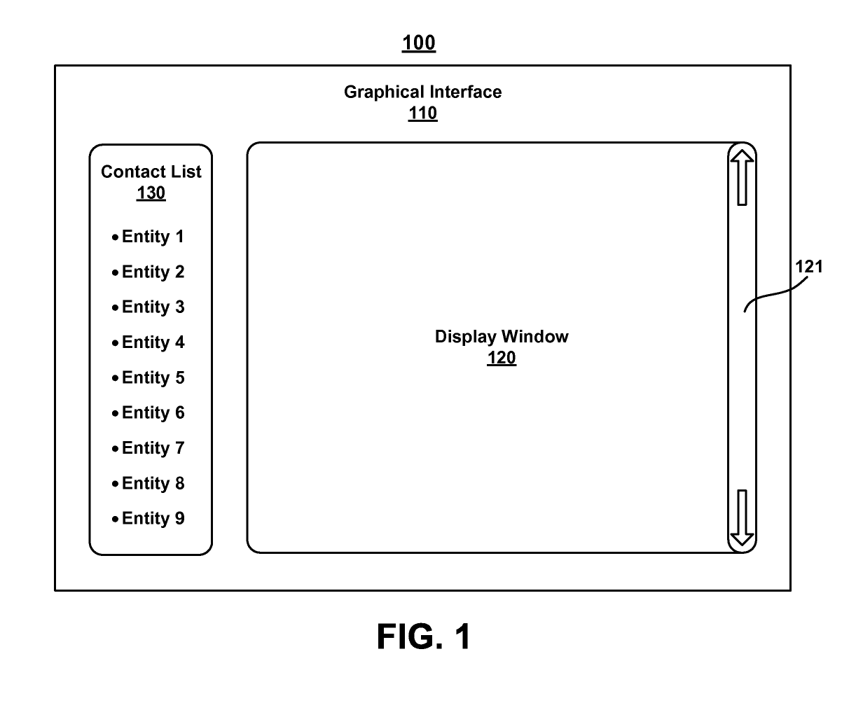

As stated above, a user may chose to share information that is currently displayed in a GUI. Various display configurations may be implemented within the spirit and scope of the present technology. With reference now to FIG. 1, an exemplary display configuration 100 in accordance with an embodiment is shown. Exemplary display configuration 100 includes a graphical interface 110 that is configured to display information to a user. In particular, a display window 120 is displayed in graphical interface 110, wherein display window 120 is utilized to present specific data content to a user.

For example, the content presented in display window 120 may include graphical information such as a natural or synthetic image, or video content. Moreover, such content may include static content, such as a text document, data spreadsheet or slideshow presentation, or dynamic content, such as a video game or a movie clip that includes video content.

Thus, an embodiment provides that display window 120 is utilized to present an application in graphical interface 110. In an embodiment, display window 120 is displayed within a fraction of graphical interface 110 such that other information may be shown in a remaining portion of graphical interface 110. Alternatively, a full screen version of the application may be running graphical interface 110. Therefore, the spirit and scope of the present technology is not limited to any single display configuration.

With reference still to FIG. 1, a user chooses to share information associated with the content presented in display window 120 with one or more entities. Various exemplary methods of selecting such content and entities are described herein. However, the spirit and scope of the present technology is not limited to these exemplary methods. Once the content presented in display window 120 is identified, a sharing session is established. During this sharing session, the content that is presented in display window 120 is encoded as a set of still images that comprise a video representation of such content. This video representation may then be shared with one or more identified entities.

Furthermore, in accordance with an embodiment, audio content associated with the graphical content presented in display window 120 may also be shared with a receiver. Consider the example where a video is presented in display region 120, wherein an amount of dialog is associated with the video. An audio output device, such as an audio speaker, is implemented such that a user may simultaneously experience both the audio and video content. Moreover, an embodiment provides that both the audio and video content may be shared with a selected receiver during a same sharing session. However, a user may also restrict the information being shared to a specific content type such that either the audio data or the video data is shared with the selected receiver, but not both.

The foregoing notwithstanding, in an embodiment, display window 120 displays a portion of the information in graphical interface 110, while another portion of such content is not displayed, even though the non-displayed portion is graphical in nature. However, the non-displayed portion of the content is subsequently presented within display window 120 in response to a selection of such portion. To illustrate, and with reference still to FIG. 1, display window 120 includes a scroll bar 121 that allows a user to scroll through the information to access a previously non-displayed portion of such content. The previously non-displayed portion is accessed in response to such scrolling, and presented in display window 120. Thus, in an embodiment, scroll bar 121 enables a user to select a different view of a presented application, and such view is then displayed within display window 120.

Pursuant to one embodiment, the size of display window 120 within graphical interface 110 is adjustable, and the content presented in display window 120, as well as the information shared during a sharing session, is altered based on how display window 120 is resized. Consider the example where display window 120 displays a portion of a selected file while another portion of the file is not displayed. A user selects an edge of display window 120 using a cursor, and drags the edge to a different location within graphical interface 110. In response, the dimensions of display window 120 are expanded based on a present location of the selected edge subsequent to the dragging. Moreover, the expanded size of display window 120 allows another portion of the information, which was not previously displayed, to now be presented within display window 120. In response, a graphical representation of this other portion is generated and shared during a sharing session such that the graphical impression of the displayed content includes the newly displayed view of such content.

In an alternative embodiment, the size of display window 120 is decreased, and a smaller portion of the information is presented in display window 120 in response to the reduction of such size. Moreover, less graphical information is encoded during the sharing session based on this size reduction such that the shared graphical representation may be utilized to generate an impression of the new graphical view.

Thus, in the illustrated embodiment, a portion of graphical interface 110 shows display window 120, which is utilized to present specific graphical information to a user. Additionally, an embodiment provides that another portion of graphical interface 110 may be reserved for another application.

With reference still to FIG. 1, graphical interface 110 further includes a contact list 130. As shown in the illustrated embodiment, contact list 130 may be visibly presented in a portion of display application 110. Alternatively, contact list 130 may be embedded within a system tray, such as when a full screen version of an application is displayed. Moreover, contact list 130 presents a finite list of entities with which the user may chose to share information, such as information associated with the content presented in display window 120.

Consider the example where graphical interface 110 is integrated with a data source that may be used to route data to one or more receivers, and a particular application, such as a video file, is displayed in display window 120. Contact list 130 identifies one or more entities with which the data source may attempt to establish a communication session. In particular, when a user selects an entity from among the contact list, the data source invites the selected entity to watch/receive a graphical representation of the content that is currently being displayed in display window 120. If this invitation is accepted, the data source establishes a communication session with a receiver associated with the selected entity, and routes the graphical representation to the receiver such that the graphical representation is accessible to such entity.

Different types of communication networks may be utilized to route an invitation to a selected entity within the spirit and scope of the present technology. For example, the invitation may be routed to the selected entity over the Internet, over a telephony network, such as a public switched telephone network (PSTN), or over a radio frequency (RF) network.

Furthermore, different methods of inviting a selected entity to share specific information may be implemented within the spirit and scope of the present technology. In an embodiment, an electronic message is generated, wherein the electronic message details an offer to share a graphical impression of certain graphical content with a selected receiver, and this message is used to communicate the offer to the receiver. For example, the message is formatted as an electronic mail (“e-mail”) or instant message (IM), and the data source sends the formatted message to the selected entity using a transmission protocol associated with the selected message type. In a second example, the invitation is embedded in a webpage, and the webpage is then published such that the invitation is accessible to the entity upon accessing such webpage.

To further illustrate, an embodiment provides that a link is generated that carries parameters configured to launch a sharing application at the receiver so that it can access the appropriate session. The link is provided to the receiver, such as by means of an e-mail or IM, or publication in a Website. Alternatively, websites may be populated with RSS feeds carrying these live links, and when a receiver clicks on one of these links, a browser plug-in (e.g., an ActiveX control) is launched. In this manner, a sharing application is initiated with the parameters carried in the link.

Pursuant to one embodiment, the data source is configured to share the information in real-time. For example, after specific graphical content has been identified, the data source initiates a sharing session and then encodes the graphical content as a set of still images that comprise a video representation of such content. The data source then routes this video file to a receiver in response to the receiver agreeing to join the sharing session. The sequence of still images that comprise the video file are then displayed in a GUI associated with the receiver such that a graphical impression of the aforementioned graphical content is created in such GUI. In so much as a graphical representation of the content is transmitted, rather than a copy of the content itself, various video encoding paradigms may be implemented such that the graphical representation may be transmitted at a relatively quick rate of speed, such as in real-time, and such that the aforementioned graphical impression may be generated with a relatively high degree of visual quality, even when such information is communicated over a lossy network.

Moreover, in an embodiment, contact list 130 presents zero or more identifiers associated with zero or more receivers, and the data source generates an invitation to join a sharing session when one of such identifiers is moved adjacent to display window 120. For example, a user initiates a sharing session such that the content that is currently displayed in display window 120 is encoded as a video file. In addition, the user selects an identifier shown in contact list 130, such as with a mouse cursor, and drags the selected identifier over display window 120. When the user releases or drops the identifier within display window 120, the data source invites the receiver associated with such identifier to join the sharing session that was previously created. If the receiver accepts this invitation, the data source routes the generated video file to the receiver.

Thus, in accordance with an embodiment, a drag and drop method of entity selection is implemented, such as by an information sharing application. Such a drag and drop implementation increases the ease with which a user may select entities with which to share information. Indeed, in one exemplary implementation, the user is able to invite multiple entities to a sharing session, for the purpose of sharing a graphical representation of specific graphical content, by dropping different identifiers from contact list 130 within display window 120 when display window 120 is presenting such content.

The foregoing notwithstanding, pursuant to one embodiment, the broadcasting functionality is embedded in an application. Consider the example where the broadcasting functionality is embedded in a particular video game. The application is run by a computer such that the video game is output to a user in a GUI. Moreover, a view of this video game is broadcast to one or more receivers in response to the user selecting a “broadcast now” command, which may be linked to a graphical button displayed in the application such that the user may select the aforementioned command by clicking on the button. In particular, selection of this command initializes a sharing application, and causes the sharing application to capture the view of the video game.

In an embodiment, graphical interface 110 further identifies the status (e.g., online or offline) of the various contacts. For example, contact list 130 identifies a number of contacts associated with a data source, and each of these contacts is further identified as being currently connected or disconnected to a communication network that is utilized by the data source to share information. In this manner, a user may quickly identify the contacts that are presently connected to the network, and the user may chose to share a graphical representation of specific content with one or more of these users, such as by selecting their respective graphical identifiers from contact list 130 and dropping such identifiers into display window 120.

Thus, in accordance with an embodiment, an information sharing application enables a user to initiate a sharing session. Indeed, this application may be further configured to enable a user to halt or modify a session that has already been established. For example, after an invitation to share a specific graphical representation has been accepted, a sharing session is initiated between a data source and a receiver. However, in response to receiving a revocation of authority to share such information with the receiver, the data source halts the session such that data is no longer routed from the data source to the receiver. In this manner, an embodiment provides that once an invitation to share specific information has been extended to a selected receiver, the invitation may be subsequently revoked.

In one embodiment, different types of communication sessions may be implemented, such as different sessions corresponding to different levels of information privacy or sharing privilege. To illustrate, in an example, a sharing session is designated as an “open”, or unrestricted, sharing session. In so much as the sharing session is considered open, the receiver that receives the shared data from the data source is permitted to share the access to the session with another receiver which was not directly invited by the source of the broadcast. In this manner, the session is characterized by a relatively low degree of privacy.

Alternatively, a second example provides that a session is designated as a restricted sharing session. Consider the example where the data that is being shared between the data source and the selected receiver is confidential in nature. The data source communicates to the receiver that the receiver may be permitted access to such data, but that the receiver is not permitted to forward the data on to another receiver without the express consent of the data source. Indeed, in one embodiment, the acceptance of these terms by the selected receiver is a condition precedent to the data source granting the selected receiver with access to such data.

Different methods of designating a sharing session as restricted may be implemented within the spirit and scope of the present technology. For example, an established session may be flagged as restricted such that information shared during the restricted session is also deemed to be of a restricted nature. Alternatively, a data stream that is shared during a restricted session may be flagged as restricted such that the receiver is able to recognize the restricted nature of such data stream upon its receipt. Indeed, pursuant to one embodiment, the communicated data stream is provided with one or more communication attributes, and one of the provided attributes is a privacy attribute. This privacy attribute is set according to whether the data stream is considered restricted or unrestricted by the data source.

Moreover, an embodiment provides that information encoded during a sharing session is encrypted, and for restricted sessions, the delivery of the encryption key is tied to an access control mechanism which checks whether a particular receiver has access. In an alternative embodiment, however, the information that is encoded during a sharing session may or may not be encrypted.

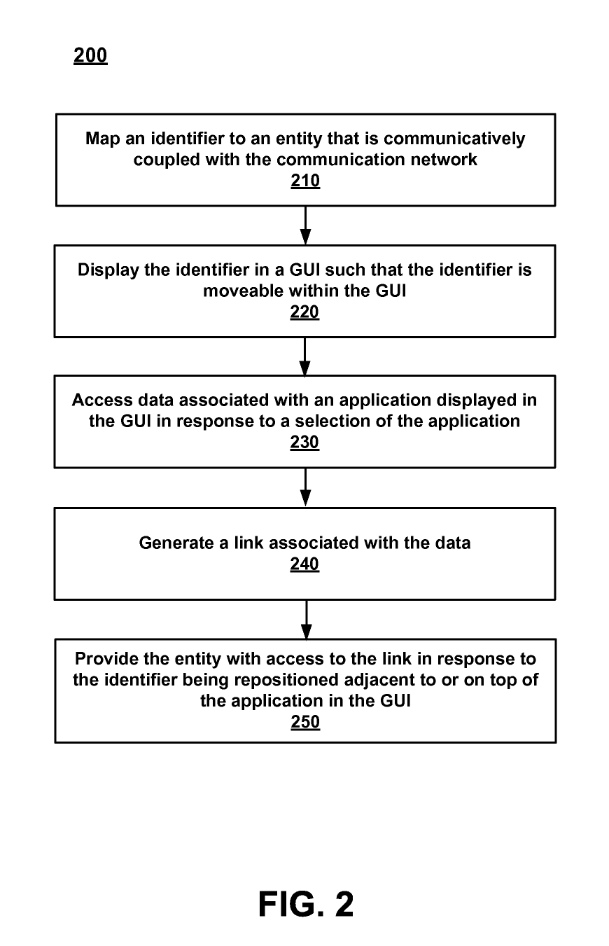

With reference now to FIG. 2, an exemplary method of providing access 200 to information over a communication network in accordance with an embodiment is shown. Exemplary method of providing access 200 involves mapping an identifier to an entity that is communicatively coupled with the communication network 210, and displaying the identifier in a GUI such that the identifier is moveable within the GUI 220. Exemplary method of providing access 200 further involves accessing data associated with an application displayed in the GUI in response to a selection of the application 230, generating a link associated with the data 240, and providing the entity with access to the link in response to the identifier being repositioned adjacent to or on top of the application in the GUI 250.

The foregoing notwithstanding, exemplary method of providing access 200 may be further expanded to include encoding the aforementioned data. To illustrate, in one embodiment, exemplary method of providing access 200 further includes establishing a sharing session in response to the selection of the application, and encoding the data during the sharing session. For example, a user selects an application that is currently displayed in the GUI when the user decides to share video and/or audio data associated with the application. In response to this selection, a sharing session is established, wherein graphical and/or audio content associated with the application are encoded.

Moreover, in an embodiment, method of providing access 200 also involves accessing a set of initialization parameters associated with the sharing session, wherein the set of initialization parameters are configured to initialize the entity for a request for the aforementioned data, and embedding the set of initialization parameters in the link. For example, the initialization parameters may designate a particular information sharing application and a specific sharing session. These parameters are embedded in the link such that a selection of the link causes the entity to load the information sharing application and request access to the aforementioned sharing session.

Various means of providing the entity with access to the generated link may be employed within the spirit and scope of the present technology. In an embodiment, exemplary method of providing access 200 involves embedding the link in an electronic message, such as an e-mail or IM, and routing the electronic message to the entity. However, in one embodiment, exemplary method of providing access 200 includes embedding the link in a webpage, and publishing the webpage such that the webpage is accessible to the entity. Consider the example where the link is an Internet hyperlink, and this hyperlink is embedded in a webpage such that a selection of this hyperlink initializes a receiver to receive the encoded information.

The foregoing notwithstanding, in an embodiment, exemplary method of providing access 200 further involves providing the entity with access to the data in response to a selection of the link. For example, a link is provided to the entity, wherein the link includes a set of initialization parameters associated with a sharing session. A selection of this link by the entity causes the data source to allow the entity to access a visual depiction of the application, as well as compressed audio content associated with the application. Indeed, pursuant to one implementation, the data source transmits such information to the entity in response to a selection of the link.

### Data Capture, Encoding and Distribution

As previously discussed, an embodiment provides that selected information is routed over a communication network to an identified receiver, such as in response to the initiation of a communication session between a data source and the receiver. However, prior to being routed over such a communication network, in an embodiment, the selected information is first encoded. Consider the example where a view of an application is displayed in a display window in a GUI. In response to a user choosing to share this view with one or more entities, such view is encoded as a series of still images, wherein the sequence of these images may be utilized at a receiver to generate a video image/impression of the shared view. In this manner, rather than sharing the graphical content of the application, a graphical impression of such content is shared.

Moreover, an embodiment provides that audio content associated with the selected application may be shared once this audio content has been sufficiently encoded. To illustrate, once the aforementioned view is selected, audio content associated with the corresponding application is captured and then encoded into a different format. In particular, the audio data is condensed into a new format such that less data is utilized to represent the aforementioned content. In this manner, the communication of the information between the data source and the receiver will involve the transfer of a smaller amount of data across the network, which will enable the receiver to receive the content faster and more efficiently.

Various exemplary implementations of encoding the selected information will now be explored. While the exemplary implementations discussed herein demonstrate principles of various exemplary embodiments, the present technology is not limited to such embodiments. Indeed, other embodiments may also be implemented within the spirit and scope of the present technology.

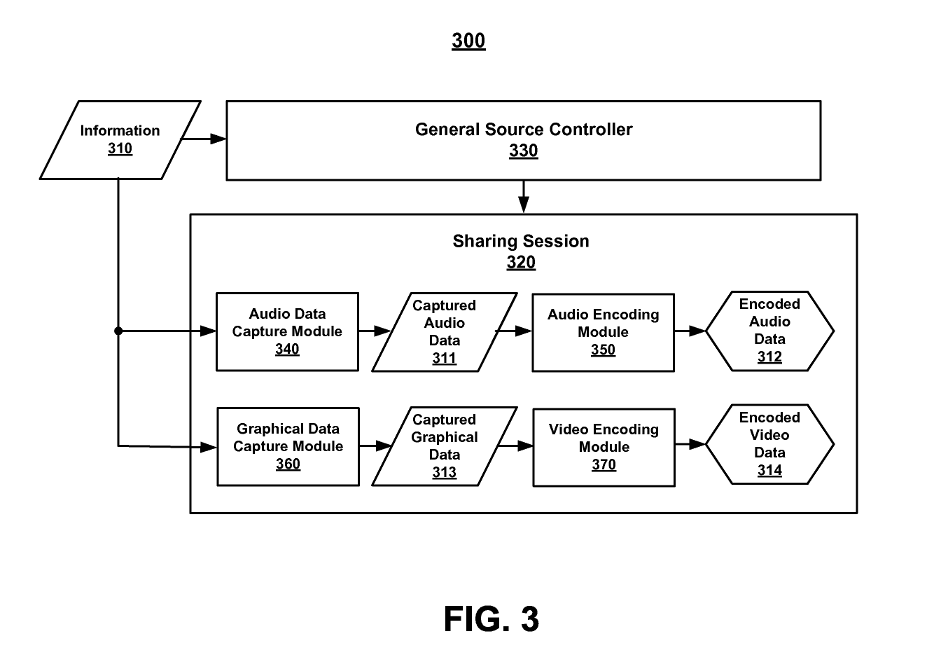

With reference now to FIG. 3, an exemplary media capture and encoding configuration 300 in accordance with an embodiment is shown. In response to a data source identifying information 310 as information to be shared over a communication network, a sharing session 320 is established. Next, one or more media capture modules and media encoding modules are allocated to sharing session 320 depending on the nature of the media associated with information 310. The allocated capture and encoding modules are then used to capture and encode information 310 during the duration of sharing session 320.

To further illustrate, and with reference still to FIG. 3, an embodiment provides that a general source controller 330 conducts an analysis of the data associated with information 310 to determine whether information 310 includes audio content and/or graphical content. For example, a media file may include a video, wherein the video data is made up of multiple natural or synthetic pictures. Some of these pictures include different images such that streaming these images together over a period of time creates the appearance of motion. Additionally, the media file may also include an amount of audio content that correlates to the video content, such as a voice, song, melody or other audible sound. Thus, general source controller 330 is implemented to analyze information 310, determine the nature of the media content associated with information 310, and allocate one or more specialized media capture and encoding modules based on such determination.

General source controller 330 may be configured to analyze the substance of information 310 in different ways. In an embodiment, graphical information may be graphically represented using an array of pixels in a GUI. Therefore, the graphical content is electronically represented by graphical data that is configured to provide a screen or a video graphics card with a graphical display directive, which communicates a format for illuminating various pixels in a GUI so as to graphically represent the aforementioned content. Thus, general source controller 330 is configured to analyze information 310 so as to identify such a graphical display or image formatting directive.

Moreover, in an embodiment, information 310 includes an amount of audio content that represents a captured audio waveform, which may be physically recreated by outputting the audio content using an audio output device, such as an audio speaker. To illustrate, consider the example where information 310 includes an audio waveform that is digitally represented by groups of digital data, such as 8-bit or 16-bit words, which represent changes in the amplitude and frequency of the waveform at discrete points in time. General source controller 330 analyzes information 310 and identifies the audio content based on audio output directives associated with such content, such as directives that initiate changes in audio amplitude and frequency over time.

Thus, an embodiment provides that when sharing a graphical impression of a view of a window in a GUI, the audio output of a computer may or may not be shared, depending on an issued sharing directive. In one embodiment, only the audio produced by the application responsible for displaying the window is shared. However, in accordance with one implementation, the audio from a microphone or from a recording device is shared in addition to the view of the window.

With reference still to FIG. 3, if general source controller 330 concludes that information 310 includes an amount of audio content, general source controller allocates an audio data capture module 340 and an audio encoding module 350 to sharing session 320. Audio data capture module 340 is configured to capture audio content from information 310 based on an audio format associated with the audio content. For example, audio data capture module 340 may be configured to locate an audio buffer of a computer system in which specific audio data of interest is stored, and make a copy of such data so as to capture the specific information of interest. The captured audio data 311 is then routed to audio encoding module 350, which then encodes captured audio data 311 based on this content type to create encoded audio data 312.

Consider the example where a portion of captured audio data 311 includes data representing one or more high frequency sounds. If audio encoding module 350 determines that a high compression of such high frequency sounds would significantly degrade the sound quality of captured audio data 311, audio encoding module 350 implements a compression paradigm characterized by a lower degree of compression such that a greater amount of the original data is included in encoded audio data 312. Additionally, in one example, if a portion of captured audio data 311 includes data representing a low frequency voice signal, audio encoding module 350 implements a high compression paradigm to create encoded audio data 312 if audio encoding module 350 determines that a significant amount of compression will not significantly degrade the quality of the low frequency voice signal. The foregoing notwithstanding, however, any type of audio compression technique may be implemented.

Similarly, and with reference again to the embodiment illustrated in FIG. 3, upon concluding that information 310 includes graphical content, general source controller 330 allocates a graphical data capture module 360 and a video encoding module 370 to sharing session 320. Graphical data capture module 360 is configured to capture the graphical data based on the graphical nature of such data. For example, graphical data capture module 360 may be configured to identify a location in video card memory that contains the view of the shared window, and then copy this view so as to capture the graphical data of interest. The captured graphical data 313 is then routed to video encoding module 370, which encodes captured graphical data 313 to create encoded graphical data 314.

To illustrate, an example provides that information 310 includes graphics, and graphical data capture module 360 captures the graphics. Next, video encoding module 370 determines whether the captured graphics include a static image or a sequence of still images representing scenes in motion. Video encoding module 370 then encodes the captured graphics based on the presence or lack of a graphical motion associated with the content of these graphics.

Thus, in accordance with an embodiment, the allocated data capture modules are configured to capture specific media content based on the audio or graphical nature of such media content. In one implementation, however, general source controller 330 provides a data capture directive that communicates how specific content is to be captured. For example, audio data may be associated with a particular application, or may be input from an external microphone. General source controller 330 identifies the source of the audio data such that audio data capture module 340 is able to capture only the identified source.

To further illustrate, an embodiment provides that different display buffers are used to store different portions of a graphical media application prior to such portions being presented in a GUI. In addition, one or more of such portions are designated as content to be shared during a particular sharing session, while other portions of the application are not to be shared. In response, general source controller 330 directs graphical data capture module 360 to capture data from specific display buffers that are currently being used to store data associated with the aforementioned designated portions.

Consider the example where a video application, such as a video game that utilizes sequences of different synthetic images to represent motion in a GUI, includes multiple different views of a particular scene such that a user can direct the application to switch between the various views. Each of the views that are capable of currently being displayed in the GUI is stored in a different set of buffers such that a selected view may be quickly output to the GUI. In response to a specific view being identified as information to be shared during a particular sharing session, the view is captured from the group of buffers from which the data corresponding to such view is currently being stored. Furthermore, in one implementation, graphical data capture module 360 is utilized to capture data that is not currently being displayed in a GUI. In this manner, and with reference again to FIG. 1, information may be shared whether or not such content is currently presented in display window 120.

Thus, an embodiment provides that different data sets associated with an application are stored in different portions of memory, and general source controller 330 directs an allocated data capture module to capture data from a specific memory location based on the data being stored at such location being designated as data content to be shared during a specific sharing session. In one implementation, this communication between general source controller and the allocated data capture modules is ongoing so as to enable the switching of content to be shared during a same session.

Moreover, an embodiment provides that the captured audio is not specifically associated with the selected application. For example, the captured audio could include audio data associated with another application, or could include the multiplexed result of several or all of the applications running on a computer. To further illustrate, consider the example where a user is simultaneously sharing the sounds that are being output from an active video game (e.g., sounds of explosions that take place during the game) as well as music that is being played by a media application, wherein such media application is not associated with the video game application.

Once an amount of media content has been captured, an embodiment provides that such content is encoded by an encoding module that specializes in encoding data pertaining to this specific media type, such as audio encoding module 350 or video encoding module 370. Such a specialized encoding module may be configured to encode the media-specific information in different ways and in accordance with different encoding standards, such as H.264, MPEG-1, 2 or 4, and AAC. However, the present technology is not limited to any single encoding standard or paradigm.

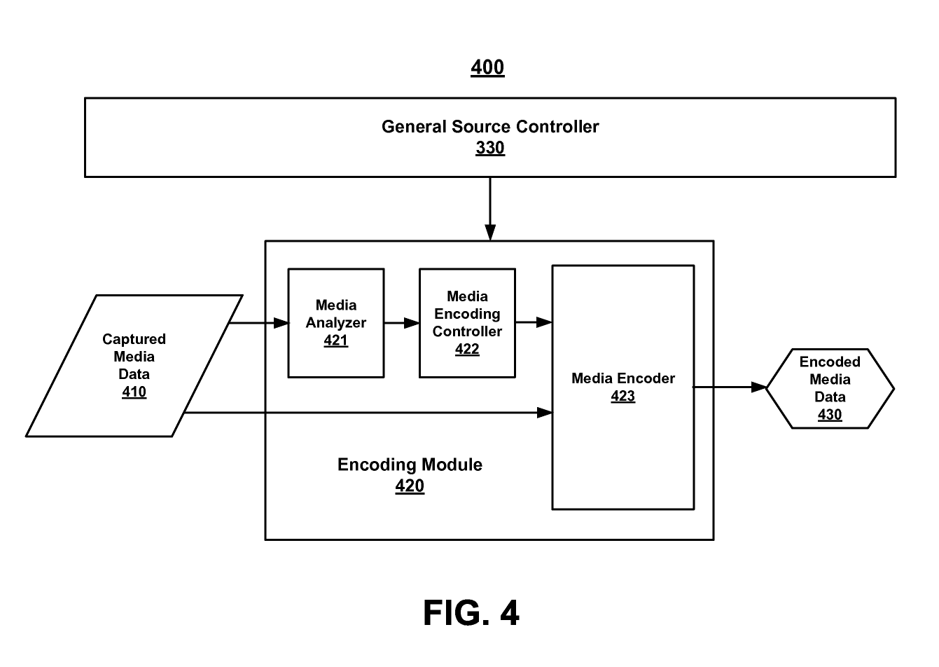

With reference now to FIG. 4, an exemplary media encoding configuration 400 in accordance with an embodiment is shown. An amount of captured media data, represented as captured media data 410, is routed to an encoding module 420, which includes a media analyzer 421, media encoding controller 422 and media encoder 423. Media analyzer 421 extracts descriptive information from captured media data 410, and relays this information to media encoding controller 422. Media encoding controller 422 receives this descriptive information, along with a set of control data from general source controller 330. Media encoding controller 422 then selects one or more appropriate encoding settings based on such descriptive information and the control data. The selected encoding settings and captured media data 410 are then routed to media encoder 423, which encodes captured media data 410 based on such encoding settings to create encoded media data 430.

As stated above, media analyzer 421 is configured to extract descriptive information from captured media data 410. In accordance with an embodiment, media analyzer 421 processes captured media data 410 to determine a specific content type (e.g. synthetic images, natural images, text) associated with captured media data 410. This can be done, for example, on the whole image, or region by region. Moreover, various tools and implementations may be implemented, such as running a text detector that is configured to identify text data. Additionally, the identified descriptive information may be utilized to determine other information useful to the encoding process, such as the presence of global motion. Once acquired, the descriptive information is then routed to media encoding controller 422, which selects a particular encoding setting based on the identified content type.

To further illustrate, an embodiment provides that based on the aforementioned processing of captured media data 410, media analyzer 421 determines whether the data stream at issue corresponds to text, or active video. The identified content type is then communicated to media encoding controller 422, which selects a particular encoding setting that is suited to such content type. Consider the example where media analyzer 421 determines that captured media data 410 includes an amount of text data, such as in the form of ASCII content. Since a high compression of ASCII data can cause the text associated with such data to be highly distorted or lost, media encoding controller 422 selects a low compression scheme to be used for encoding such text data. In contrast, if media analyzer 421 determines that a portion of captured media data 410 includes video content, wherein the video content includes one or more still images, a high compression scheme is selected, since humans are generally capable of discerning images despite the presence of relatively small amounts of image distortion.

With reference still to FIG. 4, after media encoding controller 422 has selected an appropriate encoding setting, media encoder 423 encodes captured media data 410, or a portion thereof, based on this setting. In an embodiment, media analyzer 421 identifies multiple different content types associated with captured media data 410, and media encoding controller 422 consequently selects multiple different encoding settings to be used by media encoder 423 to encode different portions of captured media data 410.

To illustrate, in accordance with an example, captured media data 410 includes both ASCII text and a video image. Media encoding controller 422 selects two different encoding settings based on these two identified content types. Next, media encoder 423 encodes the portion of captured media data 410 that includes the text data in accordance with a selected encoding setting corresponding to such text data. Similarly, media encoder 423 encodes another portion of captured media data 410 that includes the video image in accordance with the other selected encoding setting, which corresponds to the image data. In this manner, the encoding of captured media data 410 is dynamically altered based on content type variations in the data stream associated with captured media data 410.

Thus, media encoding controller 422 selects a particular encoding setting based on input from media analyzer 421, and media encoder 423 encodes captured media data 410 based on this setting. However, the present technology is not limited to the aforementioned exemplary implementations. In one implementation, if an image frame includes a natural or synthetic image as well as an amount of text data, such as when text is embedded within an image, the portions of the frame corresponding to these different content types are encoded differently. Indeed, an embodiment provides that different portions of the same frame are compressed differently such that specific reproduction qualities corresponding to the different content types of these frame portions may be achieved.

To further illustrate, an exemplary implementation provides that media analyzer 421 indicates which portions of a captured image frame includes text and which portions include synthetic images. Based on this information, media encoding controller 422 selects different encoding settings for different portions of the frame. For example, although synthetic images may be highly compressed such that the decoded images are still discernable despite the presence of small amounts of imaging distortion, the portions of the image that include text data are encoded pursuant to a low compression scheme such that the text may be reconstructed in the decoded image with a relatively high degree of imaging resolution. In this manner, the image is compressed to a degree, but the clarity, crispness and legibility associated with the embedded text data is not sacrificed.

Moreover, in an embodiment, media analyzer 421 indicates whether global motion is associated with consecutive images in an image sequence, and the motion search performed by media encoder 423 is biased accordingly. Media encoding controller 422 then selects an encoding setting based on the presence of such global motion, or lack thereof. Consider the example where an active video stream is captured, wherein the displayed video sequence experiences a global motion such as a tilt, roll or pan. In so much as portions of a previous frame are present in a subsequent frame, but in a different relative location of the subsequent frame, the aforementioned portion of the previous frame is encoded along with a representation of its relative displacement with respect to the two frames.

Furthermore, in accordance with one embodiment, portions of consecutive image frames that are not associated with motion are designated as skip zones so as to increase the efficiency of the implemented encoding scheme. Consider the example where media analyzer 421 identifies portions of consecutive image frames that include graphical information that is substantially the same. This information is routed to media encoder 423, which encodes the macroblocks corresponding to such portions as skip blocks. Media encoder 423 may then ignore these skip blocks when conducting a motion prediction with respect to the remaining macroblocks.

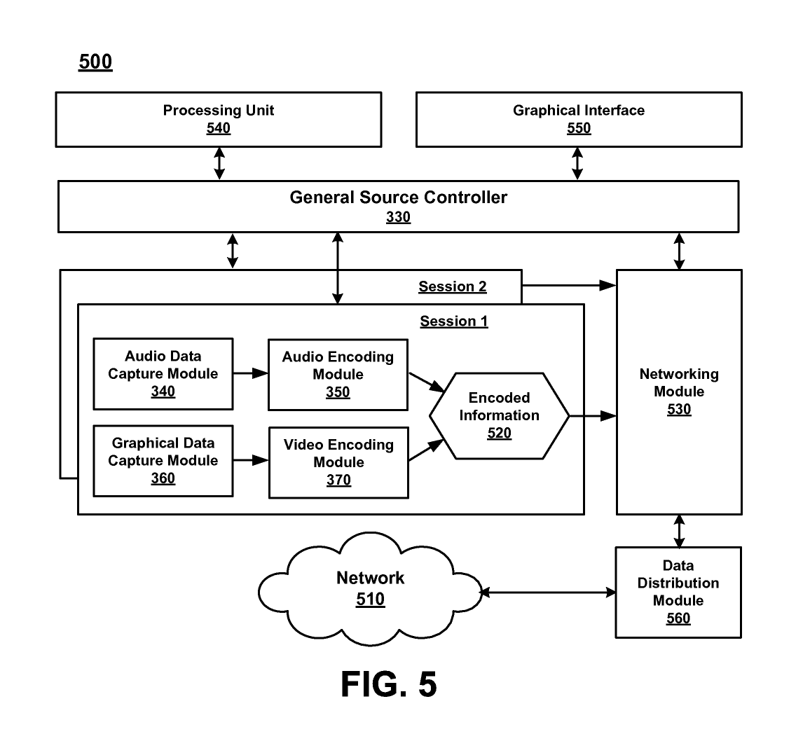

With reference now to FIG. 5, an exemplary data sharing configuration 500 in accordance with an embodiment is shown. A sharing session, represented as “Session 1”, is established in response to a decision to communicate specific information over a network 510. General source controller 330 identifies information to be shared between the data source and a receiver, and allocates one or more data capture and encoding modules to Session 1 based on the nature of such information. Once the identified information has been encoded, encoded information 520 is routed to a networking module 530, which forwards encoded information 520 over network 510.

The foregoing notwithstanding, in an embodiment, the encoding of the captured information is a continuous process. To illustrate, graphical images are captured, encoded and transmitted, and this chain of events then repeats. Therefore, an embodiment provides for live, continuous streaming of captured information.

With reference still to the embodiment illustrated in FIG. 5, general source controller 330 has identified that the information to be shared includes both audio data and graphical data. Thus, general source controller 330 allocates audio data capture module 340 and audio encoding module 350, as well as graphical data capture module 360 and video encoding module 370, to Session 1. Next, audio encoding module 350 and video encoding module 370 encode information captured by audio data capture module 340 and graphical data capture module 360, respectively, based on controller information provided by general source controller 330. This controller information may be based on one or a combination of various factors, and is used by the allocated encoding modules to select and/or dynamically update an encoding setting pursuant to which the captured information is encoded.

Thus, general source controller 330 issues encoding directives to a sharing session based on one or more criteria. Pursuant to one embodiment, general source controller 330 utilizes feedback associated with network 510 to generate controller information. The allocated encoding modules then utilize this controller information to select encoding settings that are well suited to network conditions presently associated with network 510.

Consider the example where general source controller 330 communicates with networking module 530 to identify an available bandwidth or level of throughput associated with network 510. If general source controller 330 determines that network 510 is capable of efficiently routing a greater amount of information than is currently being provided to network 510 by networking module 530, general source controller 330 directs the allocated encoding modules to utilize lower data compression schemes to encode the captured information such that a quality of the shared information may be increased. Alternatively, if general source controller 330 identifies a relatively low bandwidth or level of throughput associated with network 510, general source controller 330 generates controller information that directs the encoding modules to implement a higher data compression paradigm such that less data will traverse network 510 during a communication of the shared information.

In an embodiment, networking module 530 issues a processing inquiry, and in response, general source controller 330 identifies an unused portion of the processing capacity of a processing unit 540. In addition, general source controller 330 allocates this portion of the processing capacity to Session 1, and then issues a data encoding directive that communicates the amount of processing power that has been allocated to Session 1. After this data encoding directive is received, audio encoding module 350 and video encoding module 370 encode the captured information based on the allocated processing power.

In one embodiment, the processing power that is allocated to Session 1 is divided between audio encoding module 350 and video encoding module 370 based on the amount of data to be encoded by each module. For example, if the shared information includes an amount of audio data and an amount of graphical data, a fraction of the allocated processing power is allotted to audio encoding module 350 based on the amount of audio data that audio encoding module 350 is to encode with respect to the total amount of information to be encoded during a duration of Session 1. Similarly, another fraction of the allocated processing power is allotted to video encoding module 370 based on the amount of graphical data that video encoding module 370 is to encode with respect to the aforementioned total amount of information.

Moreover, in an embodiment, the processing power that is allocated to Session 1 is divided between audio encoding module 350 and video encoding module 370 based on the type of data to be encoded by each module. Consider the example where the shared information includes an amount of graphical content in the form of an active video file, as well as audio data that includes a musical work or composition. Based on these different content types, a high complexity compression encoding algorithm is selected to encode the video images, whereas a low complexity compression encoding algorithm is selected to encode the musical data. In so much as the execution of the high compression algorithm utilizes more processing power than the execution of the low compression algorithm, a greater amount of the allocated processing power is allotted to video encoding module 370 as compared to audio encoding module 350.

The foregoing notwithstanding, in accordance with one embodiment, general source controller 330 recognizes an interaction with graphical interface 550, and generates a data encoding directive based on this interaction. To illustrate, and with reference again to FIG. 1, an example provides that a user interacts with a portion of graphical interface 110, such as by scrolling through content presented in display window 120, resizing display window 120, or displacing an entity identifier from contact list 130 within or adjacent to display window 120. General source controller 330 identifies this action, and issues an encoding directive to audio encoding module 350 and video encoding module 370 based on the nature of such action.

To further illustrate, an example provides that an application presented in display window 120 includes an amount of displayed content and non-displayed content. An encoding setting is selected based on one or more content types associated with the displayed content, and the displayed content is encoded based on this encoding setting so as to create a video impression of such content. The encoded information is provided to networking module 530, which forwards the information over network 510, while the non-displayed content associated with the presented application is not shared over network. However, when a user enlarges display window 120, or scrolls through data associated with the presented application using scroll bar 121, a previously non-displayed portion of the content is presented in display window 120. In response, general source controller 330 generates a new data encoding directive based on a newly presented content type associated with the previously non-displayed portion. In this manner, the encoding of the captured information may be dynamically updated over time in response to user interactions with a user interface.

Various encoding paradigms may be implemented within the spirit and scope of the present technology. In an embodiment, the encoding of the information involves encrypting the captured data so as to protect against unauthorized access to the shared information. For example, subsequent to being condensed, the selected information is encrypted during a duration of Session 1 based on an encryption key. The encrypted data is then forwarded to networking module 530, which routes the encrypted data over network 510 to one or more receivers that have joined Session 1. The receivers then decrypt the encrypted information, such as by accessing a particular decryption key. In this manner, the captured information is encrypted so as to protect against unauthorized access to the shared information, as well as the unauthorized interference with a communication between a data source and a receiver.

Thus, an embodiment provides for implementing an encryption scheme to protect the integrity of a data communication during a sharing session. Various methods of encrypting and subsequently decrypting the information may be implemented within the spirit and scope of the present technology. Indeed, the present technology is not limited to any single encryption, or decryption, methodology.

In an embodiment, encoded information 520 is packetized during a duration of Session 1 based on a transmission protocol associated with network 510. Consider the example where encoded information 520 is divided up into multiple groups of payload data. Multiple data packets are created wherein each data packet includes at least one group of payload data. Networking module 530 acquires these data packets and forwards them to network 510, where they may then be routed to a selected receiver that is communicatively coupled with network 510. In one embodiment, however, networking module 530 forwards the data packets to a data distribution module 560, which is responsible for communicating the packets with a set of receivers over network 510. Data distribution module 560 may or may not be collocated on the same computer as module 530.

The foregoing notwithstanding, pursuant to one embodiment, networking module 530 rearranges a sequence of the generated data packets, and then routes the rearranged data packets over network 510. For example, when encoded information 520 is packetized, each data packet is provided with header information such that the collective headers of the different data packets may be used to identify an original sequence associated with such packets. Moreover, if networking module 530 determines that the payloads of particular data packets are more important to the shared information than payloads of others, networking module 530 will route the more important packets before the less important packets. The receiver can then rearrange the received packets into their original sequence based on their respective data headers.

Thus, an embodiment provides that a communication session may implement different encoding paradigms based on the type of data to be encoded as well as encoding directives provided by general source controller 330. To illustrate, a single sharing session may be established so as to share a view of an application, and/or audio content associated therewith, with one or more receivers. However, the present technology is not limited to the implementation of a single sharing session existing during a particular time period. Indeed, pursuant to one embodiment, exemplary data sharing configuration 500 includes multiple sharing sessions existing simultaneously, wherein these sharing sessions are used to capture and encode the same or different information during a same time period.

With reference still to FIG. 5, exemplary data sharing configuration 500 includes the aforementioned sharing session, represented as “Session 1”, as well as a different sharing session, which is represented as “Session 2”. In an embodiment, Session 1 and Session 2 are each dedicated to sharing different information over network 510. For example, Session 1 is established such that specific information may be captured and encoded prior to being forwarded over network 510 by networking module 530. Next, general source controller 330 allocates one or more data capture and encoding modules to Session 1 based on the information to be shared during a duration of Session 1. Moreover, the information to be shared during Session 1 is encoded based on a communication bandwidth associated with a set of receivers that has joined Session 1. In this manner, Session 1 is customized to efficiently share information with the aforementioned receiver based on the type of data to be shared as well as the communication capabilities of a set of receivers.

With reference still to the previous example, Session 2 is established for the purpose of sharing different information over network 510, and is allotted one or more data capture and encoding modules based on the information that is to be shared with a different set of receivers that has joined Session 2. Additionally, the information to be shared during Session 2 is encoded based on a communication bandwidth associated with this different set of receivers. In this manner, both communication sessions are customized so as to efficiently share information with different sets of receivers based on the type of data that each session is to share as well as the communication capabilities the sessions' corresponding set of receivers.

Thus, in accordance with an embodiment, Session 1 and Session 2 share different information with different sets of receivers. Consider the example where a selected application includes both audio and video content. The set of receivers that corresponds to Session 1 is able to realize a relatively significant communication bandwidth. Networking module 530 identifies the bandwidth associated with such set of receivers and routes this information to general source controller 330. General source controller 330 analyzes this bandwidth and decides that the receiver will be able to efficiently receive a significant amount of audio and video information associated with the selected application over network 510. Consequently, general source controller 330 allocates audio data capture module 340 and audio encoding module 350, as well as graphical data capture module 360 and video encoding module 370, to Session 1, and directs Session 1 to implement an encoding setting that will yield a high quality impression of the shared information.

With reference still to the previous example, networking module 530 identifies the communication bandwidth associated with the set of receivers corresponding to Session 2, and forwards this information to general source controller 330. Upon analyzing this information, general source controller 330 concludes that this set of receivers does not have a significant amount of free bandwidth. Thus, general source controller 330 directs Session 2 to implement an encoding setting that will yield a lower quality impression of the shared information. In this manner, despite a relatively low bandwidth being associated with a set of receivers, the encoding implemented during a sharing session may be adjusted such that both the audio and video information associated with a selected application may nonetheless be shared with such receivers.

In an embodiment, general source controller 330 initiates and terminates different communication sessions, such as when the initiation or termination of such sessions is indicated by a user using graphical interface 110. Additionally, general source controller 330 determines which session modules are needed and updates this information periodically. For example, audio information may be enabled or disabled for a particular session at different times by allocating and de-allocating audio modules at different times during the duration of such session.

In one embodiment, networking module 530 simultaneously supports multiple sessions. Consider the example where network 510 is a peer-to-peer communication network, and a particular peer within network 510 is simultaneously part of multiple sessions, such as when the aforementioned peer functions as the data source for one session and a receiver for another session. Networking module 530 routes data to and from such peer during the duration of both sessions such that the peer does not replicate networking module 530 or allocate a second networking module. In this manner, the transmission of data to other peers within network 510 may be regulated by one central controller.

Indeed, utilizing a single networking module avoids multiple instances of an application competing for a computer's resources, such as the processing power or throughput associated with a particular system. Consider the example where a portion of a computer's processing power is allocated to networking module 530 such that networking module 530 is able to transmit or receive data packets associated with a first session during a first set of clock cycles, and then transmit or receive data packets associated with a second session during a second set of clock cycles, wherein both sets of clock cycles occur during the simultaneous existence of both communication sessions.

Moreover, in an embodiment, that general source controller 330 also exchanges information with networking module 530 so as to maximize the efficiency of a particular encoding paradigm. Consider the example where networking module 530 is a peer-to-peer networking module that is configured to route information over an established peer-to-peer network. In particular, networking module 530 functions as a gateway between a data source and one or more receivers that are communicatively coupled with such peer-to-peer network. Networking module 530 periodically reports to general source controller 330 an estimated available throughput associated with a data path within the peer-to-peer network. General source controller 330 then determines an encoding rate for one or more communication sessions based on the reported throughput.

Moreover, in accordance with an embodiment, general source controller 330 determines which fraction of the estimated available throughput is to be reserved as a forwarding capacity for each session. To illustrate, an exemplary implementation provides that general source controller 330 divides the available throughput evenly among the different sessions. Alternatively, general source controller 330 may provide different portions of the available throughput to different sessions, such as when one session is to share a greater amount of information than another session.

Furthermore, pursuant to one embodiment, general source controller 330 selects encoding rates which achieve an essentially equivalent degree of quality for the content that is to be shared by the different sessions. Consider the example where each session module reports statistics on the content that each session is to share, such as the complexity of the content measured as an estimated rate-distortion function. General source controller 330 selects encoding rates for the respective sessions such that each session is able to share its respective content with a particular level of distortion being associated with the communication of such content over network 510. In one embodiment, a session module provides feedback to general source controller 330, such as feedback pertaining to a data packet loss associated with a particular transmission, and general source controller 330 dynamically updates one or more of the implemented encoding settings based on such feedback.

Therefore, various exemplary implementations provide that general source controller 330 communicates with one or more session modules and/or networking module 530. In one implementation, general source controller also communicates with one or more dedicated servers, such as to create new sessions, or to report statistics on the established sessions (e.g., the number of participants), the type of content being shared, the quality experienced by the participants, the data throughput associated with the various participants, the network connection type, and/or the distribution topology.

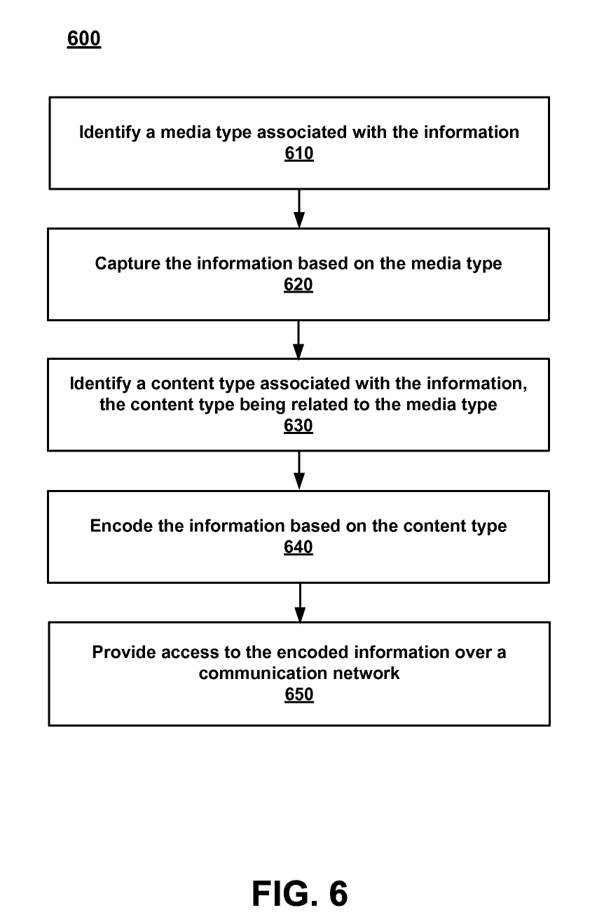

With reference now to FIG. 6, an exemplary method of sharing information 600 associated with a selected application in accordance with an embodiment is shown. Exemplary method of sharing information 600 includes identifying a media type associated with the information 610, capturing the information based on the media type 620, identifying a content type associated with the information, wherein the content type is related to the media type 630, encoding the information based on the content type 640, and providing access to the encoded information over a communication network 650.

In particular, an implementation provides that access to the encoded information is provided over a peer-to-peer communication network. For example, a set of receivers in a peer-to-peer network are utilized as real-time relays of a media stream. This allows a system to stream data to relatively large audiences (e.g., potentially millions of receivers) without a server infrastructure being utilized.

Moreover, various peer-to-peer video streaming protocols may be utilized. In particular, in one embodiment, multiple application layer multicast trees are constructed between the peers. Different portions of the video stream (which is a compressed representation of a shared window) are sent down the different trees. Since the receivers are connected to each of these trees, the receivers are able to receive the different sub-streams and reconstitute the total stream.

Indeed, an advantage of sending different sub-streams along different routes is to make optimal use of the throughput of the receivers since each of the receivers may not have sufficient bandwidth to forward an entire stream in its integrality. Rather, peers with more throughput forward more sub-streams, while those with less throughput forward less sub-streams.

As stated above, exemplary method of sharing information 600 involves identifying a media type associated with the information 610, and capturing the information based on the media type 620. For example, if the information associated with the selected application is identified as including audio content, such information is captured based on the audio-related nature of such information. Alternatively, if the information is identified as including graphical content, the information is captured based on the graphical nature of such content. In this manner, an embodiment provides for content specific data capture such that the feasibility of the capture of such data is maximized, since the media type determines where the data is to be captured from.

In an embodiment, exemplary method of sharing information 600 includes generating a graphical representation of a view of the application, wherein the view is currently displayed in a GUI, and providing access to the graphical representation during a sharing session. Consider the example where an application is displayed in a GUI, and the captured information associated with this displayed application includes audio as well as graphical content. One or more audio waveforms associated with the application are identified, and the audio content of the data stream is identified as a digital representation of such waveforms. The audio data associated with this application is then captured from the audio buffer used by the application. Similarly, one or more graphical images associated with the application are identified, and the graphical content of the data stream is identified as a digital representation of such images. The graphical data associated with the application is then captured from the video buffers used by this application.

The foregoing notwithstanding, in an embodiment, exemplary method of sharing information 600 includes utilizing a display window to display the view in a portion of the GUI. In an alternative embodiment, however, exemplary method of sharing information 600 involves generating a full screen version of the view in the GUI. Thus, the spirit and scope of the present technology is not limited to any single method of displaying information.

In one implementation, exemplary method of sharing information 600 includes determining the media type to be graphical media, and identifying the content type to be video game imaging content. For example, graphical content of a video game is shown in a window or full-screen display in a GUI. The user selects this graphical content, and a sharing session is established. A graphical representation of the selected content is generated, and this graphical representation is forwarded to a set of receivers over a peer-to-peer network. The receivers may then display this information such that other individuals are presented with the same view of the video game as such view is displayed at the data source.

In an embodiment, exemplary method of sharing information 600 involves injecting code into the selected application, receiving feedback from the selected application in response to the injecting, generating a data capture procedure based on the feedback, and capturing the information in accordance with the data capture procedure. In particular, an injection technique, such as dynamic link library (DLL) injection, is utilized so as to cause the selected application to aid in the data capture process by executing additional commands. Consider the example where a surface controlled by the application is identified, and an amount of code is injected into this application so as to request that this surface be repainted in another memory location that may be controlled. The repainted area is then forwarded to a video encoder, and consequently its corresponding media analyzer, which has been allocated to the sharing session.

As stated above, and with reference still to FIG. 6, exemplary method of sharing information 600 includes identifying a content type associated with the information, wherein the content type is related to the media type 630, and encoding the information based on the content type 640. In an embodiment, exemplary method of sharing information 600 further encompasses selecting an encoding module from among a group of encoding modules based on the encoding module being associated with the content type, wherein each of the encoding modules is configured to encode different content-related data, and utilizing the encoding module to encode the information based on an encoding setting. For example, if the information includes audio content, then an encoding module that is configured to encode audio data is selected. Moreover, an audio encoding setting is selected such that the information may be effectively and efficiently encoded based on the specific audio content associated with the information. The selected encoding module is then used to encode the information based on such encoding setting.

The foregoing notwithstanding, the present technology is not limited to the aforementioned means of selecting the encoding setting pursuant to which the information is to be encoded. In an embodiment, exemplary method of sharing information 600 includes identifying available bandwidth associated with the communication network, and selecting the encoding setting based on the available bandwidth. For example, as stated above, exemplary method of sharing information 600 involves providing access to the encoded information over a communication network 650. However, in so much as such communication network has a finite communication bandwidth, the information is compressed based on such bandwidth such that the transmission of the encoded information over the communication network is compatible with such bandwidth, and such that data associated with the encoded information is not lost during such a transmission.

In one embodiment, exemplary method of sharing information 600 includes allocating a portion of a processing capacity of a central processing unit (CPU) to the encoding module based on the content type, and selecting the encoding setting based on the portion of the processing capacity. For example, in so much as different compression schemes are used to compress different types of data, and in so much as different amounts of processing power are utilized to implement different compression schemes, the amount of processing power that is allocated to the encoding of the information is based on the type of data to be encoded. Thus, the processing capacity of the CPU is identified, and a portion of this processing capacity is allocated to the selected encoding module based on the amount of processing power that is to be dedicated to encoding the information based on the identified content type.

Moreover, in an embodiment, exemplary method of sharing information 600 includes identifying an image frame associated with the information, identifying a frame type associated with the image frame, and selecting the encoding setting based on the frame type. To illustrate, an example provides that an image frame is identified, wherein the image frame has been designated to be a reference frame. Based on this designation, an intra-coding compression scheme is selected such that the image frame is encoded without reference to any other image frames associated with the information.

Furthermore, an embodiment provides that multiple image frames associated with the information are identified. Moreover, a difference between these image frames is also identified, and the encoding setting is selected based on this difference. Consider the example where a sequence of image frames is identified, thus forming a video sequence. A graphical difference is identified between the two or more image frames from the frame sequence, wherein this graphical difference corresponds to a motion associated with the video content. An encoding setting is then selected based on this graphical difference.

To further illustrate, an example provides that one of the image frames in this sequence is identified as a reference frame. Additionally, another image frame in the frame sequence is identified, wherein such image frame is not designated as a reference frame. A difference between this other image frame and the aforementioned reference frame is identified, wherein such difference is a graphical distinction between a portion of the two frames, and a residual frame is created based on this difference, wherein the residual frame includes information detailing the difference between the two frames but does not detail an amount of information that the two frames have in common. In an embodiment, the residual frame is then compressed using a discrete cosine transform (DCT) function, such as when the images are to be encoded using a lossy compression scheme. Once both the reference frame and the residual frame have been encoded, access to such frames is provided over the communication network.

The foregoing notwithstanding, any video coding paradigm may be implemented within the spirit and scope of the present technology. Indeed, a different compression scheme that does not utilize a DCT transform may be utilized. For example, a H.264 standard may be implemented, wherein the H.264 standard utilizes an integer transform. However, other encoding standards may also be implemented.

Thus, in so much as the residual frame includes less information than the original frame that it is intended to replace in the sequence, less data is routed over the network, which allows the rate of communication of the information over the network to decrease. Moreover, in so much as the reference frame details information that the original two frames have in common, and in so much as the residual frame details the information that distinguishes the two frames, the original two frames may be reconstructed upon receipt of the transmitted data.

Once the encoding setting is selected, an embodiment provides that the encoding setting is capable of being updated over time such that content to be communicated over the network is encoded so as to increase an efficiency of such a communication. However, the present technology is not limited to any particular method of updating the selected encoding scheme. Indeed, different methods of updating the encoding setting may be employed within the spirit and scope of the present technology.

In an embodiment, feedback pertaining to a data transmission quality associated with the encoding setting is acquired, and the encoding setting is dynamically updated based on this feedback. For example, if the communication network is experiencing a high degree of network traffic, feedback is generated that communicates the amount of communication latency resulting from such traffic. The selected encoding setting is then adjusted based on the degree of latency such that a higher data compression algorithm is implemented, and such that less data is routed over the network during a communication of the information.

Different methods of initiating a sharing session may be implemented within the spirit and scope of the present technology. In one embodiment, exemplary method of sharing information 600 includes initiating a sharing session in response to a selection of a broadcasting function integrated with the selected application, and providing access to the encoded information during the sharing session. Consider the example where a broadcasting function is embedded in a video game application. The video game application is run by a computer such that the video game is displayed to a user. When the user selects the embedded broadcasting function, the video game application executes the function, which causes a sharing application to be initialized. The sharing application then captures a view of the video game, as it is currently being displayed to the user, and this view is shared with a set of receivers over a communication network.

Moreover, in an embodiment, exemplary method of sharing information 600 involves generating a link comprising a set of parameters configured to identify a sharing session, wherein a selection of the link launches a sharing application, providing a set of receivers that is communicatively coupled with the communication network with access to the link in response to a selection of the receiver, and providing the set of receivers with access to the encoded information in response to a selection of the link. For example, after a link is generated, a set of initiation parameters are embedded within the link, wherein such parameters are configured to launch a sharing application at a receiver and request access to a particular sharing session. The link is then provided to a group of receivers, such as by means of an e-mail or IM, or publication in a website. The receivers that select this link will be provided with access to the aforementioned sharing session, and the encoded information may then be shared with such receivers over, for example, a peer-to-peer network.

Pursuant to one embodiment, exemplary method of sharing information 600 further includes identifying another set of receivers that is communicatively coupled with the communication network, accessing different information associated with the selected application, and transmitting the encoded information to the set of receivers and the different information to the another set of receivers during a same time period. In this manner, an embodiment provides that multiple sharing sessions may be simultaneously active, while simultaneously being utilized to transmit different information over a peer-to-peer network.

In accordance with one embodiment, exemplary method of sharing information 600 includes utilizing multiple data routes in the communication network to transmit different portions of the encoded information to a set of receivers during a same time period, wherein the communication network is a peer-to-peer communication network. Consider the example where the encoded information is packetized, and some of the generated data packets are forwarded to a first receiver while other data packets are transmitted to a second receiver. Both the first and second receivers then forward the received data packets to one another, as well as to a third receiver. In this manner, multiple paths are utilized such that a high probability exists that each receiver will receive at least a substantial portion of the generated data packets.

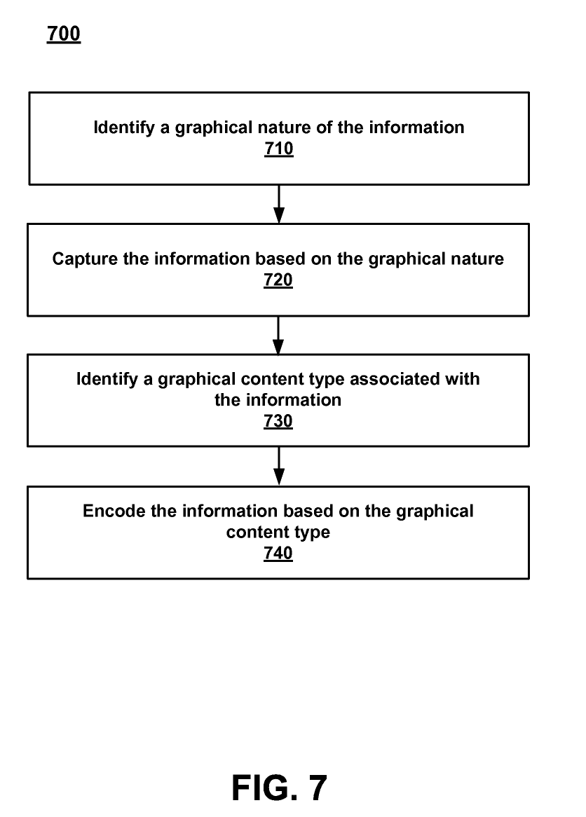

With reference now to FIG. 7, a first exemplary method of formatting information 700 for transmission over a peer-to-peer communication network in accordance with an embodiment is shown. First exemplary method of formatting information 700 includes identifying a graphical nature of the information 710, capturing the information based on the graphical nature 720, identifying a graphical content type associated with the information 730, and encoding the information based on the graphical content type 740.

Therefore, an embodiment provides that data is captured in response to such data being graphical data. Moreover, the graphical data is then encoded based on the type of graphical information associated with such graphical data. For example, when the captured content pertains to a static image that is characterized by a lack of movement, the encoding of such an image includes selecting a low data compression algorithm such that the fine line details of the image are not lost, and such that such details may be visually appreciated when the decoded content is subsequently displayed to a user.

In contrast, when the captured content pertains to a video that is characterized as having a significant amount of movement, the amount of resolution associated with such multimedia content may not be quite as important. For example, a user may be concentrating more on the movement associated with the image sequence of such video content and less on the fine line details of any single image in the sequence. Thus, a high data compression algorithm is selected and utilized to encode the captured content such that a significantly shorter data stream may be transmitted over the communication network.

In an embodiment, first exemplary method of formatting information 700 further includes identifying image frames associated with the information, conducting a motion search configured to identify a difference between the image frames, and encoding the information based on a result of the motion search. For example, specific information is captured based on the content being graphical in nature. Furthermore, the content is identified as including video content, wherein the video content includes a sequence of multiple image frames. Moreover, a graphical difference between different image frames in the sequence is identified such that the sequential display of such images in a GUI would create the appearance of motion.

Next, one of the aforementioned image frames is designated as an independent frame based on such image frame having a relatively significant amount of graphical content in common with the other image frames in the sequence. This reference frame serves as a reference for encoding the other frames in the sequence. In particular, the encoding of each of the other frames includes encoding the differences between such frames and the reference frame using an inter-coding compression algorithm. In addition, an intra-coding compression algorithm is utilized to encode the reference frame such that the encoding of such frame is not dependent on any other frame in the sequence. In this manner, the reference frame may be independently decoded and used to recreate the original image sequence in its entirety. In particular, the reference frame is decoded, and the encoded differences are compared to the reference frame so as to recreate each of the original image frames.

Thus, an embodiment provides that various image frames in an image frame sequence are not encoded in their entirety. Rather, selected portions of such images are encoded such that the data stream corresponding to the encoded video content includes less data to be transmitted over the network. However, the original image sequence may be completely recreated by comparing these image portions with the decoded reference frame.

In so much as the communication of data over a network is not instantaneous, but rather involves some degree of inherent latency, and in so much as such a network may be plagued by imperfections that cause an amount of data traversing the network to be lost, routing less data across such a network enables content to be shared faster and with a greater degree of success. Therefore, the aforementioned motion search enables a more efficient encoding scheme to be implemented such that information can be shared relatively quickly and efficiently.

In one embodiment, first exemplary method of formatting information 700 further includes identifying a global motion associated with the image frames, and biasing the motion search based on the global motion. To illustrate, an example provides that a global motion is identified when one or more graphical differences between the various image frames are not confined to a particular portion of the frames, such as when the active video image tilts, rolls or pans in a particular direction. Consequently, the motion search is applied to each frame in its entirety so that the video motion is completely identified and encoded during a compression of the video stream.

In a second example, however, a graphical difference between consecutive frames in a frame sequence is present in a particular portion of each of the frames, and other portions of such frames include graphical information that is substantially the same. As a result, these other portions are designated as skip zones, which are ignored during the encoding of the image frames. In this manner, the number of bits utilized to encode the various image frames is minimized, and the captured information is encoded quickly and efficiently.

The foregoing notwithstanding, in accordance with an embodiment, first exemplary method of formatting information 700 includes displaying a portion of the information in a window of a GUI, identifying an interaction with the window, and biasing the motion search based on the interaction. For example, and with reference again to FIG. 1, a portion of a video application is displayed in display window 120, while another portion of the application is not displayed, even though the non-displayed portion is graphical in nature. In addition, the information displayed in display window 120 is identified as content to be shared with a selected receiver. Thus, the displayed content is encoded for transmission over the communication network while the non-displayed content is not so encoded. In particular, a motion search is conducted of the data displayed in display window 120, where such motion search is tailored based on the results of a global motion analysis of such data.

However, the previously non-displayed portion of the video application is subsequently displayed in display window 120 in response to an interaction with display window 120, such as when a user scrolls through the video application using scroll bar 121, or when the user augments the size of display window 120 in the GUI. In so much as new information is now displayed in display window 120, the motion search is updated based on a newly conducted global motion analysis of the newly displayed content. In particular, the motion search bias is computed based on the scrolling. To illustrate, if a user scrolls through the graphical content by a particular number of pixels, the motion search is consequently biased by this same number of pixels.

The foregoing notwithstanding, in an embodiment, first exemplary method of formatting information 700 includes identifying an image frame associated with the information, and encoding portions of the image frame differently based on the portions being associated with different graphical content types. Indeed, pursuant to one embodiment, first exemplary method of formatting information 700 further involves identifying each of the different graphical content types from among a group of graphical content types consisting essentially of text data, natural image data and synthetic image data.

For example, if an image frame includes both text and synthetic images, the portions of the frame corresponding to these different content types are encoded differently, such as in accordance with different target resolutions associated with each of these content types. Thus, an embodiment provides that different portions of the same frame are compressed differently such that specific reproduction qualities corresponding to the different content types of these frame portions may be achieved.

As would be understood by those skilled in the art, an image sequences may include different frame types. For example, a video stream may include a number of intra-coded frames (“I-frames”), which are encoded by themselves without reference to any other frame. The video stream may also include a number of predicted frames (“P-frames”) and/or bi-directional predicted frames (“B-frames”), which are dependently encoded with reference to an I-frame. Upon receipt of a video stream, the I-frames are utilized to decode the P-frames and/or B-frames, and therefore function as decoding references.

In one embodiment, first exemplary method of formatting information 700 includes identifying a request for the information at a point in time, selecting an image frame associated with the information based on the point in time, and utilizing an intra-coding compression scheme to compress the image frame in response to the request, wherein the compressed image frame provides a decoding reference for decoding the encoded information. To illustrate, in accordance with one embodiment, a new I-frame is added to a frame sequence of a live video transmission such that a new receiver is able to decode other frames in the sequence that are dependently encoded. In this manner, I-frames may be adaptively added to a data stream in response to new receivers requesting specific graphical content that is already in the process of being shared in real time.

To further illustrate, consider the example where active video content is currently being shared between a data source and a receiver during a particular communication session in real time. This communication session has not been designated as a private session between these two entities, so one or more other receivers are capable of joining the session so as to participate in the real time transmission. However, in so much as the video stream has already began to be transmitted prior to a new receiver joining the session, the new receiver receives the portions of the data stream that are communicated over the network subsequent to, but not preceding, the point in time when such receiver joined the session. Therefore, the first frame or set of frames that the new receiver receives over the network may have been dependently encoded, which diminishes the speed with which the shared content may be decoded by the new receiver. For example, the new receiver may wait for the receipt of another I-frame to be received before the dependent frames may be decoded, which causes a delay in the transmission such that the communication between the data source and the new receiver is not in real time.

Therefore, an embodiment provides that another frame in the frame sequence is intra-coded so as to provide the new receiver with a frame of reference for decoding the dependently encoded image frames, wherein such reference frame corresponds to a point in time when the new receiver joined the session. In this manner, the new receiver is quickly presented with a reference frame such that the real time nature of the communication may be maintained for all of the receivers that are participating in the session.

Although various exemplary embodiments presented herein describe the capture of graphical information, the spirit and scope of the present technology is not limited to such. Indeed, graphical or audio data, or a combination of graphical and audio data, may be captured and encoded during a sharing session.

To illustrate, an embodiment provides a method of formatting information for transmission over a communication network, wherein the information is associated with a displayed application. The method comprises identifying the information in response to a selection of the application, identifying a media type associated with a portion of the information, and capturing the portion based on the media type. The method further comprises identifying a content type associated with the portion of the information, and encoding the portion based on the content type. Pursuant to one implementation, this portion of information may be either audio data or video data.

To further illustrate, in an embodiment, the method further includes determining the media type to be a graphical media type, and capturing the portion based on the graphical media type. Alternatively, an implementation provides that the method involves determining the media type to be an audio media type, and capturing the portion based on the audio media type.

Indeed, in accordance with one embodiment, the method includes identifying a different media type associated with another portion of the information, and capturing the other portion based on the different media type. Additionally, the method involves identifying a different content type associated with the other portion, and encoding the other portion based on the different content type. Thus an embodiment provides that both audio and video data may be captured, wherein the captured audio and video data are associated with the same data stream.

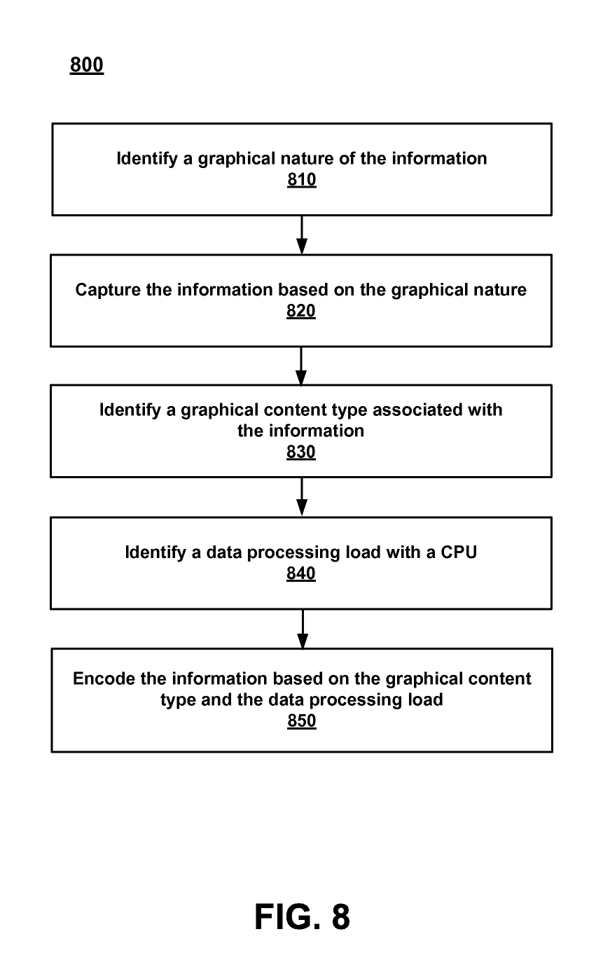

With reference now to FIG. 8, a second exemplary method of formatting information 800 for transmission over a peer-to-peer communication network in accordance with an embodiment is shown. Second exemplary method of formatting information 800 includes identifying a graphical nature of the information 810, and capturing the information based on the graphical nature 820. Second exemplary method of formatting information 800 further includes identifying a graphical content type associated with the information 830, identifying a data processing load associated with a CPU 840, and encoding the information based on the graphical content type and the data processing load 850.

For example, a particular application is selected, and graphical content associated with this application is captured based on the graphical nature of this content. In addition, a particular encoding algorithm is selected based on the type of graphical information to be encoded, and the selected algorithm is utilized to generate graphical images of the captured graphical content at discrete times, wherein the number and/or quality of such images is dependent on a current processing capacity of the CPU that is used to implement such algorithm. In this manner, the efficiency with which information is encoded is increased by tailoring the selected encoding scheme based on the resources of an available data processing unit.

In accordance with one embodiment, the captured data is encoded so as to increase a level of error protection that may be realized by a shared data stream. For example, in so much as I-frames function as decoding references, a greater number of J-frames may be included in the data stream so as to provide a receiver with a greater number of decoding references, which consequently allows the shared stream to achieve a greater degree of error protection.

In an embodiment, second exemplary method of formatting information 800 also involves identifying a current data processing capacity associated with the CPU based on the data processing load, and allocating portions of the current data processing capacity to different simultaneous sharing sessions such that data sharing qualities associated with the different simultaneous sharing sessions are substantially similar. Thus, an embodiment provides that the resources of a CPU may be shared between various sharing sessions that simultaneously exist for the purpose of sharing different information. However, such resources are divided between the various sessions so as to ensure an amount of uniformity of information quality realized by the different sessions.

In one embodiment, second exemplary method of formatting information 800 includes identifying image frames associated with the information, partitioning the image frames into multiple macroblocks, and identifying matching macroblocks from among the multiple macroblocks based on the matching macroblocks being substantially similar, wherein the matching macroblocks are associated with different image frames. Moreover, second exemplary method of formatting information 800 further includes identifying a variation between the matching macroblocks, and encoding the information based on the variation.

Consider the example where a graphical object is represented in different macroblocks associated with consecutive image frames, yet the color or hue of the object is different in such macroblocks. In so much as these macroblocks each include imaging data that is substantially similar, these macroblocks are designated as matching one another. However, in so much as the object is represented slightly differently in the matching macroblocks, due to a color or hue variation between the macroblocks' pixels, a difference between the matching macroblocks is identified, wherein such difference is quantized based on the magnitude of the variation between the aforementioned pixels. This quantized value then provides a basis for dependently encoding one of the consecutive image frames. In particular, the quantized value is used to generate a residual frame that represents a difference between the consecutive frames such that at least one of these frames is not independently encoded, and such that the amount of data in the shared data stream is minimized.

Pursuant to one embodiment, second exemplary method of formatting information 800 includes identifying a number of macroblock types associated with the macroblocks, adjusting the number of macroblock types based on the data processing load, and encoding the information based on the adjusting of the number of macroblock types. For example, an encoder is used to classify different macroblocks that occur in an image frame based on the type of image data (e.g., natural image data or synthetic image data) in the frame and the efficiency of the implemented motion estimation. Such classifications may designate the various macroblocks as independently coded blocks (“I-macroblocks”), predicted blocks (P-macroblocks), or bi-directionally predicted blocks (“B-macroblocks”).

Moreover, in so much as I-frames are independently encoded, such frames include I-macroblocks, but not P-macroblocks or B-macroblocks. In contrast, dependently encoded frames may include P-macroblocks and/or B-macroblocks, as well as a number of I-macroblocks. For example, when a particular motion prediction is not sufficiently effective so as to adequately represent the identified motion associated with a particular macroblock, the macroblock is designated as an I-macroblock such that it is independently encoded, and such that an inaccurate motion vector is not utilized.

In accordance with an embodiment, second exemplary method of formatting information 800 involves subdividing each of the plurality of macroblocks into smaller data blocks according to a partitioning mode, identifying corresponding data blocks from among the smaller data blocks, and identifying the variation based on a distinction between the corresponding data blocks. To illustrate, a macroblock that includes a 16 pixel by 16 pixel image block may be subdivided, for example, into two 16 pixel by 8 pixel image blocks, four 8 pixel by 8 pixel image blocks, or sixteen 4 pixel by 4 pixel image blocks, based on a selected partitioning parameter. The subdivided image blocks of consecutive image frames are then matched and analyzed to identify differences between the matched blocks. In this manner, the analysis of matching macroblocks corresponding to consecutive image frames is concentrated on individual portions of the various macroblocks such that the efficiency of such analysis is augmented.

However, in an embodiment, subdividing the macroblocks and conducting such an analysis of the subdivided blocks comes at a price. In particular, this more detailed analysis utilizes an increased amount of the processing capacity of the CPU. Therefore, pursuant to one embodiment, second exemplary method of formatting information 800 further includes adjusting the partitioning mode based on the data processing load associated with the CPU.

For example, a partitioning parameter is selected such that 16 pixel by 16 pixel macroblocks are subdivided into sixteen 4 pixel by 4 pixel image blocks, and such that the efficiency of the macroblock comparison is relatively high. However, in response to the processing capacity of the CPU diminishing over time, such as when a new communication session is initiated such the processing power of the CPU is divided between an increased number of sessions, a different partitioning parameter is selected such that 16 pixel by 16 pixel macroblocks are now subdivided into four 8 pixel by 8 pixel image blocks. As a result, the efficiency of the macroblock comparison is lessened to a certain degree, but so is the amount of processing power utilized during such an analysis. Therefore, an embodiment provides that the encoding efficiency is dynamically adjusted based on the available processing capacity of a CPU.

In an embodiment, second exemplary method of formatting information 800 involves accessing a search range parameter that defines a range of searchable pixels, and accessing a search accuracy parameter that defines a level of sub-pixel search precision. Second exemplary method of formatting information 800 further involves identifying the matching macroblocks based on the search range parameter, wherein the matching macroblocks are located in different relative frame locations, and defining a motion vector associated with the matching macroblocks based on the search accuracy parameter. Finally, the information is encoded based on the motion vector.

To illustrate, a graphically represented object moves between different relative frame locations in consecutive image frames, and these consecutive image frames are searched for such matching macroblocks within a specified search range. In certain implementations, this search is conducted with respect to portions of these image frames, such as to conserve precious processing power. Therefore, the search for the matching macroblocks is conducted within a specific search range, as defined by a search range parameter. In accordance with an embodiment, this search range parameter is adjusted based on the data processing load. Indeed, the implemented search range may be dynamically adjusted over time based on a change in a processing capacity associated with the CPU.

Additionally, the relative positions of each of these macroblocks in the consecutive frames provide a basis for generating a motion vector associated with the matching macroblocks. In one implementation, subsequent to identifying matching macroblocks in two consecutive image frames, the identified macroblock of the first frame is shifted by a single pixel value in a direction that substantially parallels the generated motion vector. Next, corresponding pixels in the two macroblocks are identified, wherein the corresponding pixels occupy the same relative position in their respective macroblocks, and the difference between these corresponding pixels is then determined. Finally, the difference between the two image frames is represented as the direction of the generated motion vector as well as the differences between the corresponding pixels of the two frames. This difference is then utilized to generate a residual frame, which provides a condensed representation of the subsequent image frame.

Pursuant to one embodiment, however, the accuracy with which this motion vector is defined depends on the designation of a search accuracy parameter. To illustrate, an exemplary implementation of half-pixel motion accuracy provides that an initial motion estimation in integer pixel units is conducted within a designated portion of an image frame such that a primary motion vector is defined. Next, a number of sub-pixels are referenced so as to alter the direction of the primary motion vector so as to more accurately define the displacement of the identified motion. In so much as a half-pixel level of precision is currently being implemented, an imaginary sub-pixel is inserted between every two neighboring real pixels, which allows the displacement of the graphically represented object to be referenced with respect to a greater number of pixel values. The altered vector direction is defined as a secondary motion, wherein this secondary motion vector has been calculated with a degree of sub-pixel precision, as defined by the search accuracy parameter.

Although the previous example discusses the implementation of half-pixel motion accuracy, the present technology is not limited to such a level of sub-pixel precision. Indeed, in an embodiment, second exemplary method of formatting information 800 involves selecting the search accuracy parameter from a group of search accuracy parameters consisting essentially of an integer value, a half value and a quarter value. In the event that a quarter value is selected, an example provides that sub-pixels are interpolated within both the horizontal rows and vertical columns of a frame's real pixels pursuant to a quarter-pixel resolution. Indeed, increasing the search accuracy parameter from an integer or half value to a quarter value consequently increases the accuracy with which the motion prediction is carried out.

The foregoing notwithstanding, increasing the sub-pixel resolution also increases the amount of data processing utilized during the execution of the motion prediction. In one embodiment, second exemplary method of formatting information 800 includes adjusting the search accuracy parameter based on the data processing load associated with the CPU. For example, if an integer level of motion accuracy is initially implemented, and the amount of available processing capacity associated with the CPU subsequently increases, such as when another sharing session terminates, the search accuracy parameter may be adjusted to a half or quarter pixel value so as to increase the accuracy of a defined motion vector, and consequently increase the accuracy with which the corresponding motion is encoded.

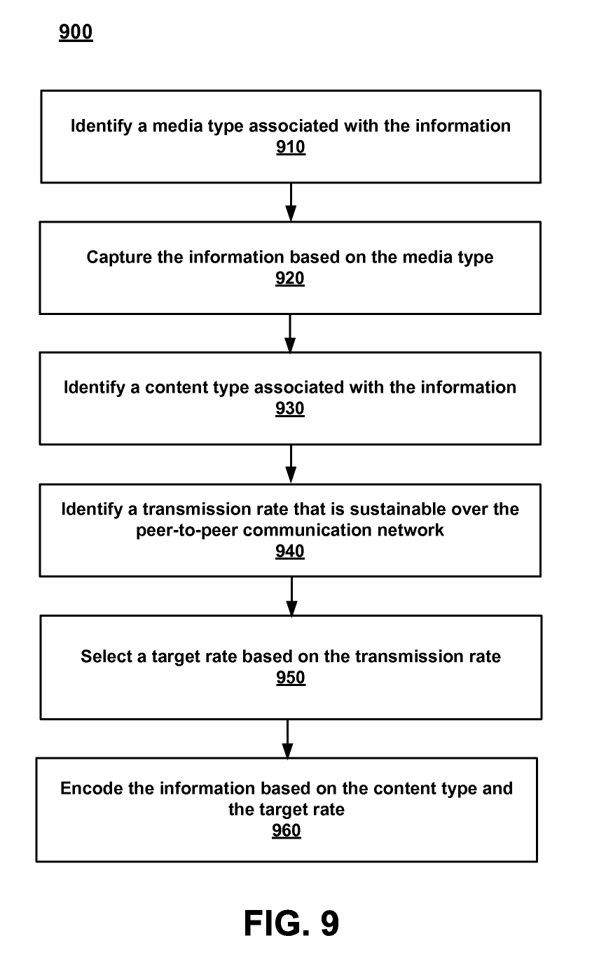

With reference now to FIG. 9, a third exemplary method of formatting information 900 for transmission over a peer-to-peer communication network in accordance with an embodiment is shown. Third exemplary method of formatting information 900 includes identifying a media type associated with the information 910, and capturing the information based on the media type 920. Third exemplary method of formatting information 900 further includes identifying a content type associated with the information 930, identifying a transmission rate that is sustainable over the communication network 940, selecting a target rate based on the transmission rate 950, and encoding the information based on the content type and the target rate 960.

Thus, an embodiment provides that the information is encoded based on a bandwidth that is sustainable over the communication network. Consider the example where a communication network is capable of supporting a particular data transmission rate of 500 kilobits per second (kbps). This transmission rate is identified, and the information is encoded such that the transmission of the encoded data is compressed to a level that may be communicated over the network in real time. Moreover, the data is compressed to a level such that portions of the data are not dropped during the real time communication of the information. For example, in so much as the network is currently capable of supporting a transmission rate of 500 kbps, a communication rate of 400 kbps is conservatively selected such that the implemented communication rate does not exceed the supported transmission rate. The information is then compressed to a level such that the compressed data stream may be communicated in real time at a rate of 400 kbps.

In sum, the information is encoded such that the corresponding real time communication rate does not exceed the transmission rate that is currently supported by the network. Indeed, an embodiment provides that the encoding of such information is dynamically adjusted over time in response to the supported transmission rate changing, such as when the network begins to experience different degrees of communication traffic.

Moreover, in accordance with one implementation, third exemplary method of formatting information 900 includes configuring a rate distortion function based on the target rate, and implementing the rate distortion function such that data sharing qualities associated with different simultaneous sharing sessions are substantially similar. For example, a rate distortion function could be implemented so as to identify a minimal degree of information that is to be communicated over different data paths within a peer-to-peer network, with regard to an acceptable level of data distortion, such that the quality associated with different information sessions is substantially similar.

In one embodiment, third exemplary method of formatting information 900 involves packetizing the encoded information to create a data stream configured for transmission over the communication network, and allocating a portion of the target rate as an error correction bandwidth based on an error resilience scheme associated with the communication network. Third exemplary method of formatting information 900 further involves generating a packet set of error correction packets based on the error correction bandwidth, and adding the packet set of error correction packets to the data stream.

For example, if the network is currently capable of supporting a transmission rate of 500 kbps, a communication rate of 400 kbps is conservatively selected such that the implemented communication rate does not exceed the supported transmission rate. Moreover, a portion of the selected communication rate is allocated to error correction, such that an error in the communicated transmission may be detected at a receiver. In an exemplary implementation, 50 kbps is dedicated to error correction, and the remaining 350 kbps is allocated to the encoding of the information. In particular, the information is encoded based on the 350 kbps of bandwidth allotted to the data load, and the encoded content is then packetized to create a data stream. Finally, one or more error correction packets are generated based on the 50 kbps of bandwidth allotted to error correction, and the generated packets are added to the data stream.

Although the previous example provides an exemplary implementation of error correction, the present technology is not limited to this implementation. Indeed, other methods of error correction may be implemented. For example, once the information is packetized, error correction packets may be associated with individual data packets, or groups of such packets.

Pursuant to one embodiment one or more forward error correction (FEC) packets are added to the data stream. For example, the data stream is divided into groups of data packets, and an FEC packet is added for every group of packets in the stream. Each FEC packet includes reconstructive data that may be used to recreate any data packet from the group of data packets associated with the FEC packet. Thus, if a data packet is lost during a transmission of the data stream across the network, the FEC packet may be used to reconstruct the lost data packet at the receiver. In this manner, an embodiment provides that lost data packets are reconstructed at a receiver rather than retransmitted over the network, which helps to preserve the real time nature of a communication as well as improve communication efficiency.

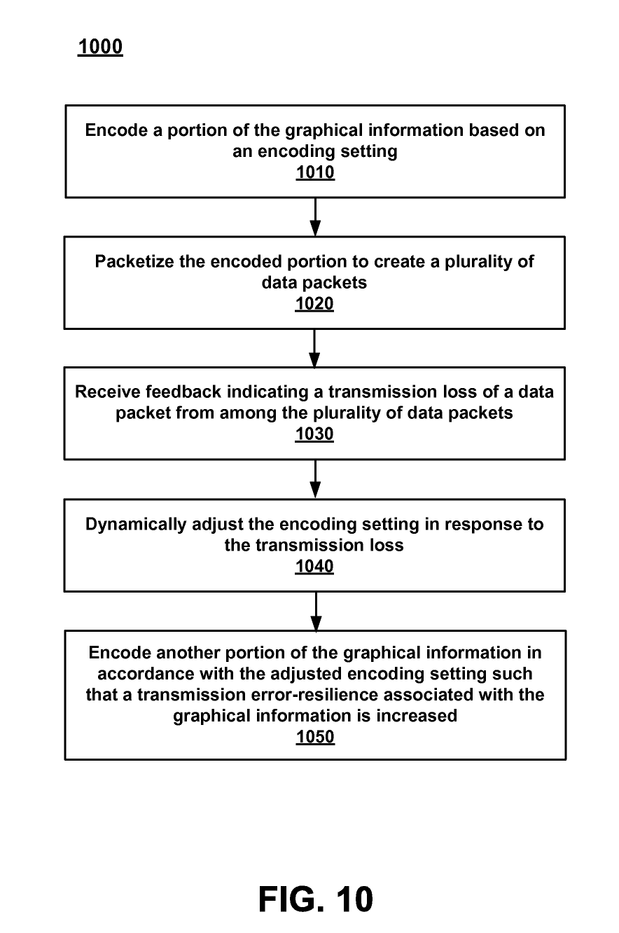

With reference now to FIG. 10, an exemplary method of encoding graphical information 1000 in accordance with an embodiment is shown. Exemplary method of encoding graphical information 1000 includes encoding a portion of the graphical information based on an encoding setting 1010, packetizing the encoded portion to create multiple data packets 1020, and receiving feedback indicating a transmission loss of a data packet from among the data packets 1030. Exemplary method of encoding graphical information 1000 further includes dynamically adjusting the encoding setting in response to the transmission loss 1040, and encoding another portion of the graphical information in accordance with the adjusted encoding setting such that a transmission error-resilience associated with the graphical information is increased 1050.

To illustrate, an exemplary implementation provides that a portion of the information is encoded and packetized. The generated data packets are then routed to a receiver over the communication network, but one or several of these data packets is lost during the transmission, such as may occur when the network experiences a sudden increase in network traffic. In response to identifying this transmission loss, another portion of the information is encoded such that the content is compressed using a higher data compression algorithm. In this manner, the portion of the information that is subsequently routed over the network includes less data as compared with the previously routed portion, which causes the probability of an occurrence of a subsequent transmission loss to diminish.

In an embodiment, exemplary method of encoding graphical information 1000 includes selecting the encoding setting based on an encoding prediction format, dynamically adjusting the encoding prediction format in response to the transmission loss, and altering the encoding setting based on the adjusted encoding prediction format. For example, a quarter pixel value is initially implemented as the search accuracy parameter for a motion search such that the motion search is conducted with a relatively high level of search accuracy. In addition, a data packet is identified as being lost during a communication over the network due to a sudden increase in network traffic, and the search accuracy parameter is adjusted to an integer value in response to such data loss such that less information is encoded during the motion search.

Therefore, in so much as the search accuracy parameter is adjusted to an integer value, an amount of motion search accuracy is sacrificed. However, since less data is ultimately routed over the network during a real time transmission of the shared content, the probability an additional amount of data being lost during the transmission is lessened. Thus, an embodiment provides that the real time integrity of a data transmission is protected by dynamically adjusting the prediction format that is used to identify and encode motion associated with the shared content.

Pursuant to one embodiment, multiple description coding may be implemented, such that a video is encoded into multiple descriptions such that receiving at least one of these descriptions enables a base layer quality to be obtained with respect to the reconstructed portion of the stream, but wherein receiving more than one, or all, of these descriptions results in a higher quality being realized. Indeed, in an embodiment, exemplary method of encoding graphical information 1000 involves varying a number of video descriptions pertaining to the graphical information in response to the transmission loss. Moreover, exemplary method of encoding graphical information 1000 further includes modifying the encoding setting based on the varied number of video descriptions.

Consider the example where different descriptions, which are associated with a portion of the same data stream, are routed over different paths within a peer-to-peer network. When one of these descriptions is lost within the network, the encoding setting is modified such that a greater number of descriptions are generated for another portion of the shared information. In this manner, the number of generated descriptions is updated over time so as to account for transmission losses over the network, and so as to aid in maintaining a particular transmission quality.

However, in so much as each of the aforementioned video descriptions includes an amount of data, including an increased number of video descriptions into a data stream causes the size of the data stream to increase. In contrast, decreasing the number of video descriptions that are included in a data stream causes the size the stream to decrease. Therefore, when a transmission loss is identified, number of video descriptions in the shared content is decreased so that less information is routed over the network. Indeed, an embodiment provides that various video descriptions associated with the shared content are ranked based on an order of importance, and the less important video descriptions are removed from the data stream while the more important descriptions are permitted to remain.

In accordance with an embodiment, exemplary method of encoding graphical information 1000 includes selecting a number of image frames associated with the graphical information as reference frames based on a referencing frequency parameter, and identifying other image frames associated with the graphical information as predicted frames. Exemplary method of encoding graphical information 1000 further includes partitioning the reference frames and the predicted frames into a number of slice partitions in accordance with a slice partitioning parameter, and selecting the encoding setting based on a difference between slice partitions of the reference frames and slice partitions of the predicted frames.

To illustrate, an exemplary implementation provides that an integer value of 3 is chosen as the slice partitioning parameter. As a result, both the reference frames and the predicted frames are partitioned into thirds (e.g., a top third, a center third and a bottom third). Next, a preliminary motion search is conducted so as to identify which portions of a set of consecutive image frames contain motion, and a subsequent localized search is used to define a motion vector associated with such portions. For example, if motion is identified in the center third of consecutive images, and not in the top and bottom thirds of such images, a localized motion search is implemented with regard to the center portions of these images while the top and bottom thirds of each image are ignored. In this manner, the efficiency with which the information is encoded is increased since the localized motion search does not take into consideration those portions of the images that have already been identified as not being associated with video motion. Indeed, in so much as a slice partition of an image frame is self-contained with respect to the other slices of the frame, such partition may be decoded without using data from the other slices.

In one embodiment, exemplary method of encoding graphical information 1000 further includes dynamically adjusting the slice partitioning parameter in response to the transmission loss, and modifying the encoding setting based on the adjusted slice partitioning parameter, such as to increase or decrease the error resilience of the data. Consider the example where a slice partitioning parameter of 3 is initially selected such that consecutive image frames are partitioned into thirds. In addition, a preliminary motion search is conducted, and the results of this search identify that motion is present in the center and bottom thirds of consecutive image frames, but not in the top thirds of such frames. Thus, different motion vectors for the center and bottom thirds of these frames are defined, and these motion vectors are used to generate residual frames that are then encoded. In so much as a significant number of motion vectors were defined during the localized motion prediction process, the accuracy with which the identified motion is encoded is relatively high.

However, in response to a transmission loss being identified, an amount of motion accuracy is sacrificed so as to increase the error resilience of the transmitted data stream. For example, the initial slice partitioning parameter of 3 is adjusted to 2, and based on this adjusted parameter, consecutive image frames are divided into halves rather than thirds. Next, a motion associated with these consecutive frames is identified in the bottom halves of such frames, but not the top halves. Therefore, a localized motion search is conducted so as to define a motion vector that estimates the motion associated with these bottom halves. In so much as a localized motion search is implemented with respect to a decreased number of image portions (e.g., corresponding bottom halves rather than corresponding center thirds and bottom thirds), less motion vectors are ultimately defined, which impacts the error resilience of the stream.

The foregoing notwithstanding, in an embodiment, exemplary method of encoding graphical information 1000 involves dynamically adjusting the referencing frequency parameter in response to the transmission loss, and modifying the encoding setting based on the adjusted frequency parameter. For example, if the information includes an active video stream, wherein the video stream includes a sequence of consecutive image frames, a number of such frames are chosen as reference frames, and these frames are independently encoded as I-frames. Moreover, other frames are designated as dependent frames, and a variation between each of these frames and a selected reference frame is identified. The identified frame variations are then used to construct residual frames, which are encoded as predicted frames (“P-frames”).

Including a greater number of I-frames in a data stream consequently provides a greater number of decoding references, which is beneficial when new receivers join communication session and/or when there are losses over the network. However, in so much as I-frames include more data than P-frames, including more I-frames in a data stream increases the amount of overall data that is to be communicated over the network. Therefore, in accordance with an embodiment, when a transmission loss is identified, such as when the network suddenly begins to experience an increased level of traffic, less I-frames are included in the data stream such that less data is routed over the network. In particular, a referencing frequency parameter is adjusted such that I-frames are included in the data stream with less frequency.

Thus, various methods of selecting an encoding setting, and dynamically adjusting this setting so as to optimize an efficiency of an implemented encoding paradigm, may be implemented within the spirit and scope of the present technology. With reference again to FIG. 4, an embodiment provides that one or more steps of the various methods disclosed herein are performed by general source controller 330. For example, in the illustrated embodiment, media encoding controller 422 is utilized to select one or more encoding settings that are to be used by media encoder 423 to encode captured media data 410. In particular, specific information pertaining to captured media data 410 is extracted or compiled by media analyzer 421, and this descriptive information is forwarded to media encoding controller 422. Moreover, media encoding controller 422 performs one or more steps from the aforementioned methods and generates controller information, which is routed to media encoding controller 422. Media encoding controller 422 then selects one or more encoding settings based on the provided descriptive information and controller information.

Indeed, in accordance with an embodiment, the encoding scheme implemented by media encoder 423 is dynamically altered in response to the information provided to encoding module 420 by general source controller 330. To illustrate, and with reference again to FIGS. 4 and 5, an embodiment provides that the generated controller information indicates that a processing load associated with processing unit 540 is relatively low, and media encoder 423 increases the motion search range, the number of macroblock partitioning modes, the number of reference frames, the number of macroblock types, and/or the motion search accuracy, such that a more significant degree of data compression is realized. Alternatively, when the controller information indicates that a processing load associated with processing unit 540 is relatively high, media encoder 423 decreases the motion search range, the number of macroblock partitioning modes, the number of reference frames, the number of macroblock types, and/or the motion search accuracy, such that less of the aforementioned processing load is dedicated to encoding captured media data 410.

The foregoing notwithstanding, an embodiment provides that media encoder 423 is configured to encode captured media data 410 based on an interaction with or change to a communication session. For example, the controller information indicates one or more user actions, such as a scrolling or resizing of content displayed in display window 120 of FIG. 1, and media encoder 423 biases a motion search of captured media data 410 based on the identified user actions. In a second example, the controller information provides an indication that a new receiver has joined a session, and in response, media encoder 423 triggers the encoding of an I-frame so as to shorten the amount of time that the new receiver will wait before acquiring a decodable frame.

Furthermore, pursuant to one embodiment, general source controller 330 is configured to communicate with networking module 530 so as to obtain new information about network 510, and the controller information is generated so as to reflect this new information. A new encoding setting may then be implemented based on this new information. For example, based on information provided by networking module 530, general source controller 330 identifies a transmission rate that is sustainable over network 510, and media encoding controller 422 indicates this rate, or a function thereof (e.g., a fraction of the identified rate), to media encoder 423. Captured media data 410 is then encoded based on this rate.

The foregoing notwithstanding, in an embodiment, general source controller 330 is utilized to increase the error resilience of a shared data stream. Consider the example where the controller information indicates the transmission rate which is sustainable over network 510, and media encoding controller 422 indicates what portion of such rate is to be used for media encoding and what portion is to be used for error resilience via network encoding. Moreover, in one embodiment, the controller information indicates losses over network 510, and media encoding controller 422 increases the error-resilience of the stream by varying the frequency of I-frames in the stream, changing the encoding prediction structure of the stream, changing the slice partitioning (such as by varying the flexible macroblock ordering setting), and/or changing the number of included video descriptions, such that a more resilient stream may be transmitted over network 510.

### Data Distribution Optimization

Once the information to be shared is encoded, the information may be transmitted over a communication network to various receivers. However, utilizing a server-based communication infrastructure to route a data stream may be costly. Additionally, initiating and accessing communication sessions utilizing a server-based sharing paradigm may be cumbersome, such as when a receiver sets up a user account with a broadcaster, and the broadcaster is required to schedule a session in advance.

In an embodiment, a data stream is forwarded to the receivers directly, without utilizing a costly server infrastructure. In particular, a data distribution topology is generated wherein the resources of individual receivers are used to route the shared content to other receivers. In this manner, various receivers are used as real time relays such that a costly and cumbersome server-based sharing paradigm is avoided. Additionally, multimedia content may be shared with a scalable number of receivers in real time, and such that the shared content is fairly high quality.

Furthermore, in accordance with an embodiment, the implemented data distribution topology is optimized by analyzing the individual resources of the various peers in the peer-to-peer network such that particular data paths are identified as being potentially more efficient than other possible data paths within the network. To illustrate, in an example, the receivers communicate their respective communication bandwidths to the data source of a real time broadcast. The data source then executes an optimization algorithm, which identifies the relatively efficient data paths within the network based on information provided by the receivers.

To further illustrate, an embodiment provides that the data source and the receivers each have a peer-to-peer networking module. These networking modules enable the different members of a session to establish a number of multicast trees rooted at the data source along which the media packets are forwarded. In particular, the receivers communicate their respective available bandwidths and associated transmission delays (e.g., the estimated round-trip times) to the data source. The data source then computes a topology wherein the receivers in the peer-to-peer network having the most available throughput and lowest relative delay are placed closer to the root of a tree. Furthermore, in one exemplary implementation, a set of receivers with sufficient available throughput to act as real time relays are identified at the data source, and different receivers from among this set of receivers are chosen to be direct descendants of the data source on different multicast trees based on the respective geographic positions of such receivers.

Thus, an embodiment provides that information pertaining to the different receivers in the network, as well as the network itself, is collected at the data source, which then builds a data distribution topology based on the collected information. The data source then routes this topology to the various receivers such that the topology may be implemented. This is in contrast to a fully distributed communication paradigm wherein the receivers determine for themselves the destinations to which they will route the shared content. Indeed, in accordance with an embodiment, the efficiency of the implemented topology is optimized by providing the data source with the decision-making power such that a single entity can collect a comprehensive set of relevant information and identify a particular topology that is characterized by a significant degree of communication efficiency.

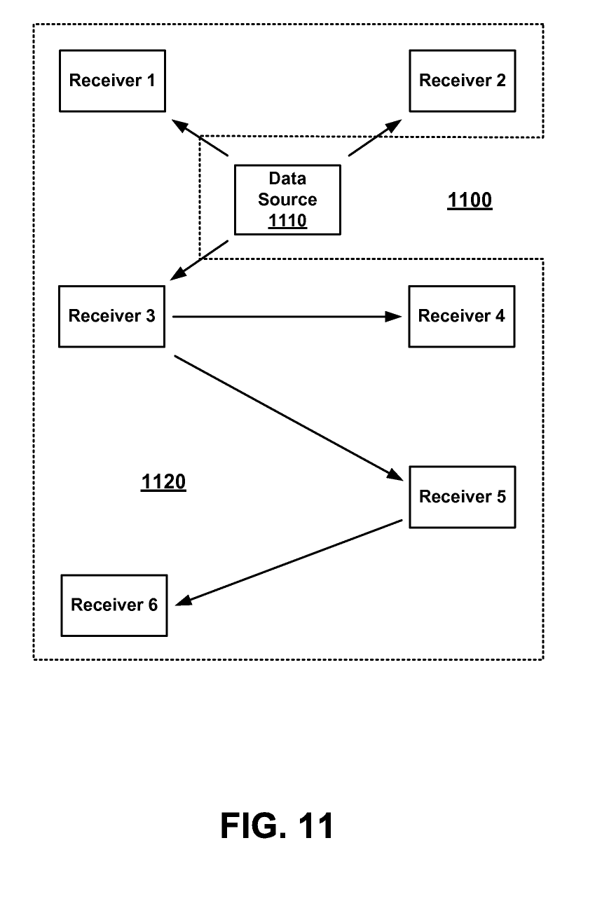

With reference now to FIG. 11, a first exemplary data distribution topology 1100 in accordance with an embodiment is shown. A data source 1110 sends information to a group of receivers 1120 that are communicatively coupled with data source 1110. However, in so much as data source 1110 has a finite amount of communication bandwidth, attempting to simultaneously communicate information to each of the receiver from among group of receivers 1120 is inefficient, and possibly ineffective. Thus, an embodiment provides that data source 1110 utilizes the resources of one or more of these receivers to route information to other receivers from among group of receivers 1120. Moreover, first exemplary data distribution topology 1100 is generated so as to map an efficient data routing scheme based on the resources of these receivers.

With reference still to FIG. 11, receivers from among group of receivers 1120 are numerically represented as Receivers 1-6. Data source 1110 is able to efficiently communicate information to three receivers from among group of receivers 1120 based on a communication bandwidth currently available to data source 1110. In so much as communicating data over longer distances is characterized by a greater degree of communication latency, and in so much as the selected receivers may be used to route the shared content to other receivers from among group of receivers 1120, these three receivers are selected based on the distance between such receivers to data source 1110 and/or a data forwarding capability of these receivers.

To illustrate, and with reference still to FIG. 11, Receivers 1 and 2 are identified as being located relatively close to data source 1110. Therefore, first exemplary data distribution topology 1100 is configured such that data source 1110 transmits information to both of Receivers 1 and 2 during a same time period without the aid of any other receivers from among group of receivers 1120. Additionally, Receivers 3 and 4 are identified as being located relatively close to data source. However, in so much as data source 1110 is transmitting information to Receivers 1 and 2, and in so much as data source 1110 can efficiently transmit content to a third receiver during the aforementioned time period, but perhaps not to a fourth receiver, either Receiver 3 or Receiver 4 is selected as the third receiver.

Next, a data forwarding capability of Receiver 3 is compared to a data forwarding capability of Receiver 4 so as to identify which of the two receivers would be better suited to forwarding the information to other receivers from among group of receivers 1120. For example, Receivers 3 and 4 may be using different electronic modems to communicate over the network, wherein a different communication rate is associated with each of these modems. Each of Receivers 3 and 4 is queried as to the communication specifications associated with its respective modem, as well as the amount of bandwidth that each receiver is currently dedicating to other communication endeavors, and the results of these queries is returned to data source 1110.

With reference still to the illustrated embodiment, the results of the aforementioned queries are received and analyzed by data source 1110, and a communication bandwidth that is presently available to Receiver 3 is identified as being greater than a communication bandwidth that is currently available to Receiver 4. Therefore, it is determined that Receiver 3 is better suited for routing information to other receivers. As a result of this determination, data source 1110 transmits the information to Receiver 3, and utilizes Receiver 3 to route the information to Receiver 4.

With reference still to FIG. 11, Receiver 5 is determined to be located closer to Receiver 4 than to Receiver 3. However, in so much as Receiver 4 is currently unable to route information to Receiver 5, due to a low communication bandwidth currently being realized by Receiver 4, Receiver 3 is utilized to route information from data source 1110 to Receiver 5.

Finally, Receiver 6 is determined to be located closer to Receiver 3 than to Receiver 5. However, in so much as Receiver 3 is already routing information to two receivers (Receiver 4 and Receiver 5), Receiver 3 does not currently have a sufficient amount of available bandwidth to dedicate to an additional transmission. Therefore, in so much as Receiver 5 has a greater amount of available bandwidth, as compared to Receiver 3, Receiver 5 is utilized to route information to Receiver 6.

Thus, pursuant to an embodiment, first exemplary data distribution topology 1100 demonstrates an example of an optimized data distribution topology, wherein a distance/bandwidth analysis is implemented so as to optimize the effectiveness of the communication of information from a single data source to multiple data receivers. In one embodiment, information is communicated from data source 1110 in real time by utilizing one or more receivers (such as Receivers 1, 2 and 3) from among group of receivers 1120 as real time relays.

Moreover, in an embodiment, data is shared between data source 1110 and group of receivers 1120 over a peer-to-peer network. For example, in contrast to a server-based sharing paradigm wherein each receiver connects to a server maintained by a service provider in order to gain access to a communication session, a peer-to-peer communication session is established between data source 1110 and Receivers 1, 2 and 3. The content to be shared with Receivers 1, 2 and 3 is encoded using specialized media encoders configured to encode the content being shared these receivers based on the type of data associated with such content. The encoded content is then packetized and a peer-to-peer streaming protocol is employed wherein the data forwarding capabilities of Receivers 3 and 5 are used to forward parts of the packetized data stream to Receivers 4 and 6. In this manner, multimedia data, such as multimedia content that is currently being presented by a user interface at data source 1110, may be shared with a scalable number of receivers in real time and with an acceptable quality, without requiring a cumbersome infrastructure setup.

Thus, an embodiment provides that data packets are routed to various peers over a peer-to-peer network. In one implementation, the various peers receive the same data stream. However, different data streams may also be shared with different peers in accordance with the spirit and scope of the present technology.

In an embodiment, the encoding settings of each of the aforementioned encoders are adapted on the fly so as to optimize the quality of the data stream based on the resources available to the various receivers. For example, if the transmission bandwidth associated with Receiver 4 begins to diminish over time, the encoding settings used to encode the information that is to be routed from data source 1110 to Receiver 3 are altered such that a higher data compression algorithm is implemented. In this manner, less information is routed to Receiver 4 such that the diminished bandwidth of Receiver 4 does not disrupt a real time transmission of the aforementioned information.

Moreover, by dynamically adjusting the encoding of the shared content at data source 1110, an amount of communication latency associated with re-encoding the content at Receiver 3 is avoided. Rather, the resources of both Receivers 3 and 4 are identified at data source 1110, and the shared content is encoded at data source 1110 based on these resources such that the content may be routed in real time without being reformatted at a communication relay. However, the spirit and scope of the present technology is not limited to this implementation. Indeed, a communication paradigm may be implemented that allows for intermediate transcoding, such that intermediary peers within a network may manipulate data that is being transmitted through the network.

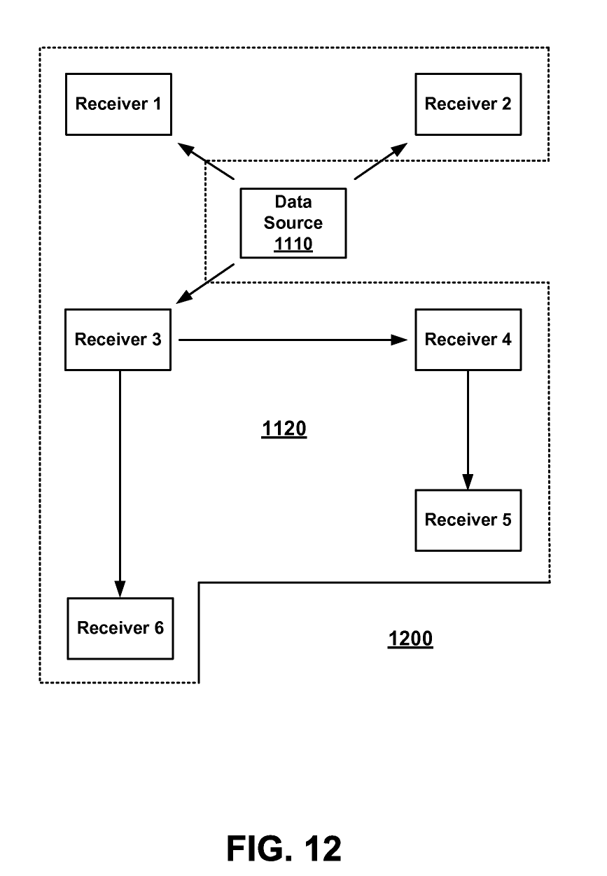

The foregoing notwithstanding, in an embodiment, first exemplary data distribution topology 1100 is altered, updated or replaced over time, such as in response to a change in resources associated with data source 1110 or one or more receivers from among group of receivers 1120. To illustrate, and with reference now to FIG. 12, a second exemplary data distribution topology 1200 in accordance with an embodiment is shown. The communication bandwidth utilized by Receiver 5, which is used to route information to Receiver 6 in first exemplary data distribution topology 1100, diminishes to the point that Receiver 5 is no longer able to efficiently route information to Receiver 6. Thus, second exemplary data distribution topology 1200 is generated so as to increase the efficiency of the data distribution paradigm.

In particular, the data forwarding capabilities of receivers from among group of receivers 1120 are analyzed with respect to the distance of such receivers relative to one another and/or data source 1110 in order to identify a new topology pursuant to which an efficiency of a communication of the shared content may be optimized. In the illustrated embodiment, each of Receivers 3 and 4 is identified as being able to route information to at least one receiver from among group of receivers 1120. Moreover, Receiver 5 is identified as being located closer to Receiver 4 than Receiver 3, while Receiver 6 is identified as being located closer to Receiver 3 than Receiver 4. Thus, second exemplary data distribution topology 1200 is configured such that Receiver 3 routes information to Receivers 4 and 6, while Receiver 4 routes content to Receiver 5.

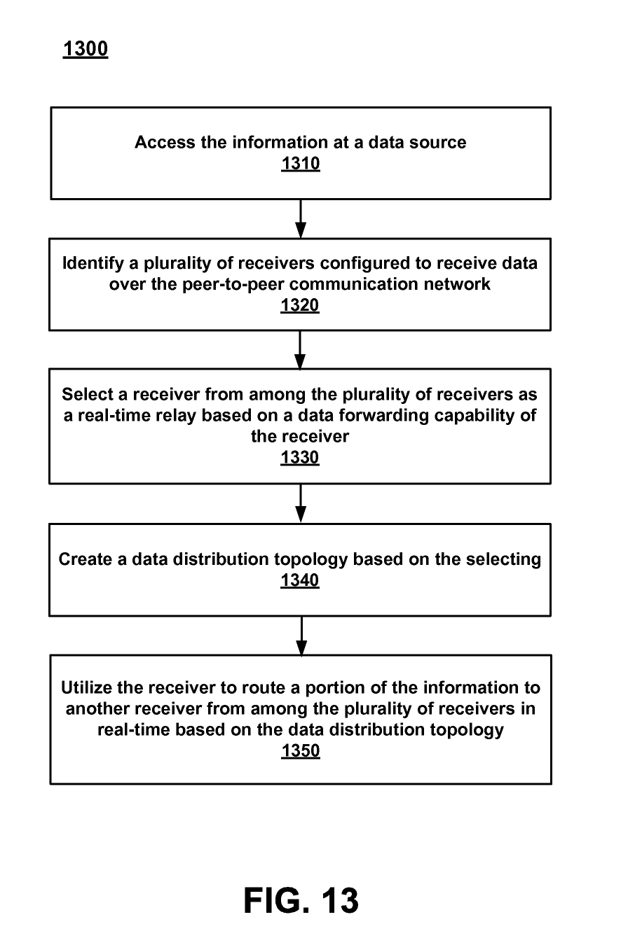

With reference now to FIG. 13, an exemplary method of sharing information over a peer-to-peer communication network 1300 in accordance with an embodiment is shown. Exemplary method of sharing information over a peer-to-peer communication network 1300 involves accessing the information at a data source 1310, identifying multiple receivers configured to receive data over the peer-to-peer communication network 1320, and selecting a receiver from among these receivers as a real-time relay based on a data forwarding capability of the receiver 1330. Exemplary method of sharing information over a peer-to-peer communication network 1300 further involves creating a data distribution topology based on the selecting of the receiver 1340, and utilizing the receiver to route a portion of the information to another receiver from among the multiple receivers in real-time based on the data distribution topology 1350.

As stated above, and with reference still to FIG. 13, exemplary method of sharing information over a peer-to-peer communication network 1300 involves selecting a receiver from among these receivers as a real-time relay based on a data forwarding capability of the receiver 1330. Different methodologies may be employed for determining this data forwarding capability. In one embodiment, exemplary method of sharing information over a peer-to-peer communication network 1300 further includes identifying an available bandwidth of the receiver, identifying a distance between the data source and the receiver, and determining the data forwarding capability of the receiver based on the available bandwidth and the distance. Thus, an embodiment provides that a hybridized bandwidth/distance analysis may be implemented so as to identify an ability of a receiver to forward data to one or more other receivers, and the receiver is selected based on such ability.

Moreover, as stated above, and with reference still to FIG. 13, exemplary method of sharing information over a peer-to-peer communication network 1300 includes utilizing the receiver to route the information to another receiver from among the multiple receivers in real-time based on the data distribution topology 1350. Various methodologies of selecting this other receiver may be employed. In accordance with an embodiment, exemplary method of sharing information over a peer-to-peer communication network 1300 involves selecting the other receiver from among the multiple receivers based on a data receiving capability of the other receiver. For example, in so much as an attempt to route information to a receiver that is not currently engaged in a communication session with a data source (or with a receiver acting as an information relay) would constitute a futile communication attempt, an effort to route information to a particular receiver is attempted in response to such receiver being presently able to accept such content.

Furthermore, in an embodiment, the information is encoded based on the data forwarding capability of the receiver and the data receiving capability of the other receiver. Consider the example where a first receiver is utilized to route information to a second receiver, wherein the second receiver has less available transmission bandwidth than the first receiver. The information is compressed based on the lower transmission bandwidth associated with the second receiver such that the content may be routed directly from the first receiver to the second receiver without being reformatted at the first receiver. In this manner, the information may be efficiently routed to the second receiver such that the amount of information that is lost during such communication, as well as the degree of latency associated with such communication, is minimized.

Pursuant to one embodiment, exemplary method of sharing information over a peer-to-peer communication network 1300 includes encoding the portion of the information according to an encoding setting, and receiving feedback pertaining to a data transmission quality associated with the encoding setting. Another encoding setting is then selected based on the feedback, and another portion of the information is encoded according to the other encoding setting.

For example, a first portion of a data stream is encoded based on a transmission rate that is currently sustainable over the network, as well as an available communication bandwidth associated with the receiver, and the encoded portion is routed to the receiver over the network. Next, feedback is obtained that details a sudden drop in the available bandwidth of either the network or the receiver, and the implemented encoding scheme is dynamically altered such that a higher level of data compression is applied to a subsequent portion of the data stream. Thus, an embodiment provides that different types or levels of data encoding may be utilized during a communication session to encode different portions of a data stream differently so as to maximize the efficiency of the data distribution.

Once the information has been sufficiently encoded, the encoded content may be routed to one or more receivers over the peer-to-peer communication network. However, the present technology is not limited to any single communication protocol. Indeed, different communication paradigms may be implemented within the spirit and scope of the present technology.

For example, a file transfer protocol may be implemented wherein entire files are transmitted to first receiver, and the first receiver then routes these files to a second receiver. Pursuant to one embodiment, however, the shared information is packetized, and the individual data packets are then routed. In particular, the encoded content is packetized, and data packets are routed over the network to one or more receivers acting as real time relays. These receivers then route the data packets on to other receivers based on an implemented data distribution topology.

Moreover, each receiver that receives the data packets (whether or not such receiver is functioning as a real time relay) reconstructs the original content by combining the payloads of the individual data packets and decoding the decoded content. In an embodiment, each data packet is provided with a sequencing header that details the packet's place in the original packet sequence. In this manner, when a receiver receives multiple data packets, the receiver is able to analyze the header information of the received packets and determine if a particular data packet was not received.

Once a receiver realizes that a particular data packet was not received, the receiver may then request that the absentee packet be retransmitted such that the original information can be reconstructed in its entirety at the receiver. Pursuant to one embodiment however, a number of error correction packets, such as FECs, are added to the data stream at the data source so that the receiver may reconstruct lost data packets such that the receiver is not forced to wait for the lost packets to be retransmitted.

Furthermore, in an embodiment, the routing sequence is adjusted such that data packets that are more important than other data packets are routed prior to the transmission of less important data packets. To illustrate, an embodiment provides that exemplary method of sharing information over a peer-to-peer communication network 1300 further includes packetizing the information to create multiple data packets, conducting an analysis of an importance of each of these data packets to a data quality associated with the information, and ranking the data packets based on the analysis. Consider the example where the shared information includes active video content and an amount of textual information that describes the video content. The active video content is determined to be more important than the textual description of such video content, so the data packets that correspond to the video content are ranked higher than the data packets corresponding to the text data. In another example, however, the frame types of the various frames of the video content are identified, and the I frames are ranked higher than the P frames, while the P frames are ranked higher than any B frames.

With reference still to the previous embodiment, once the data packets are ranked, the packets are reordered based on this ranking. The selected receiver may then be utilized to route the reordered data packets to the other receiver such that the other receiver receives the more important data packets before the less important data packets. In this manner, an embodiment provides a method of prioritized data streaming.

Moreover, pursuant to one implementation, an efficiency of a data distribution paradigm may be optimized by grouping a set of receivers into subsets, identifying a largest subset from among the established subsets, and forwarding the encoded information to the largest subset of receivers. These receivers may then be used as real time relays such that the data distribution resources of the largest subset is utilized to forward the shared content to the smaller subsets. In this manner, the efficiency of the implemented data distribution topology may be further increased.

As stated above, and with reference still to FIG. 13, exemplary method of sharing information over a peer-to-peer communication network 1300 involves creating a data distribution topology based on the selecting of the receiver 1340, and utilizing the receiver to route the information to another receiver from among the multiple receivers in real-time based on the data distribution topology 1350. In an embodiment, this data distribution topology is updated over time so as to increase an effectiveness or efficiency associated with a particular sharing session. However, the present technology is not limited to any single method of updating such a data distribution topology. Indeed, various methods of updating the data distribution topology may be employed.

To illustrate, an embodiment provides that exemplary method of sharing information over a peer-to-peer communication network 1300 further involves receiving feedback pertaining to a data transmission quality associated with the data distribution topology, and dynamically updating the data distribution topology based on this feedback. For example, if a transmission bandwidth associated with the selected receiver begins to degrade to the point that the selected receiver can no longer efficiently route data to the other receiver, a different receiver is selected to route the information to the other receiver based on a data forwarding capability of such different receiver being adequate for such a routing endeavor.

The foregoing notwithstanding, pursuant to one embodiment, exemplary method of sharing information over a peer-to-peer communication network 1300 further involves recognizing a new receiver configured to receive the data over the peer-to-peer communication network, and dynamically updating the data distribution topology in response to the recognizing. For example, once the new receiver joins the peer-to-peer communication network such that the new receiver is able to receive data over such network, the data forwarding capability of the new receiver is analyzed to determine if the new receiver may be utilized to route information to one or more other receivers, such as the aforementioned other receiver. If the data forwarding capability of the new receiver is unable to efficiently route such information, the new receiver is designated as a non-routing destination receiver. The data distribution topology is then updated based on the designation of this new receiver.

Moreover, in an embodiment, exemplary method of sharing information over a peer-to-peer communication network 1300 further includes selecting a different receiver from among the multiple receivers based on a data forwarding capability of the different receiver, and utilizing the different receiver to route another portion of the information to the other receiver based on the updated data distribution topology. In this manner, new data paths may be dynamically created over time so as to maximize the efficiency of the implemented data routes.

To illustrate, an example provides that the data distribution topology is dynamically updated after a real time transmission has already begun such that a first set of data packets is routed over a first data path, and a second set of data packets is routed over a second data path based on the alteration of such topology. Consider the example where a first set of data packets associated with an active video stream is routed from a data source to a first receiver in a peer-to-peer network by using a second receiver as a real time relay. When the second receiver experiences a change in communication resources such that the second receiver is no longer able to efficiently route data to the first receiver, the data distribution topology is altered such that a third receiver is selected to route a second set of data packets associated with the video stream, based on a data forwarding capability of the third receiver.

The foregoing notwithstanding, an implementation provides that multiple routes are used to simultaneously transmit different portions of the same bit stream. Consider the example where the shared information is packetized so as to create a number of data packets. These data packets are then grouped into a number of odd numbered packets and a number of even numbered packets, based on the respective positions of such packets in the original packet sequence. Next, the odd packets are transmitted over a first route in a peer-to-peer network, while the even packets are transmitted over a second route. Both the odd and even packets may then be received by a receiver that is communicatively coupled with both of the aforementioned routes. However, in the event that one of these routes fails to forward a portion or all of the packets (e.g., the odd packets) earmarked for communication across such route, the receiver will nevertheless be able to receive other packets (e.g., the even packets) associated with the shared information.

Therefore, although the quality of the information reconstructed at the receiver may be affected when less data packets are received, utilizing a multi-route transmission paradigm increases the probability that at least a portion of the shared information will be received. Consider the example where a shared video sequence includes enough information to support an image rate of 24 frames per second. If only half of the transmitted frames are received by a receiver, then a video sequence may be reconstructed that supports an image rate of 12 frames per second. In this manner, although the quality of the video reconstructed at the receiver has been affected, the video has nevertheless been shared, which would not have occurred if only a single path had been earmarked for routing the information to the receiver, and all of the information had been lost over this single path.

### Exemplary Computer System Environment

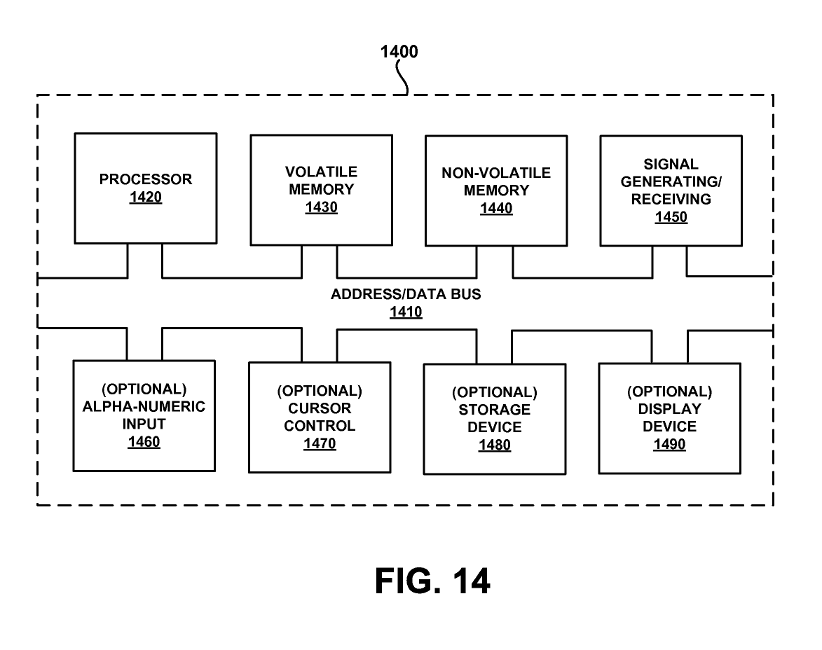

With reference now to FIG. 14, an exemplary computer system 1400 in accordance with an embodiment is shown. Computer system 1400 may be well suited to be any type of computing device (e.g., a computing device utilized to perform calculations, processes, operations, and functions associated with a program or algorithm). Within the discussions herein, certain processes and steps are discussed that are realized, pursuant to one embodiment, as a series of instructions, such as a software program, that reside within computer readable memory units and are executed by one or more processors of computer system 1400. When executed, the instructions cause computer system 1400 to perform specific actions and exhibit specific behavior described in various embodiments herein.

With reference still to FIG. 14, computer system 1400 includes an address/data bus 1410 for communicating information. In addition, one or more central processors, such as central processor 1420, are coupled with address/data bus 1410, wherein central processor 1420 is used to process information and instructions. In an embodiment, central processor 1420 is a microprocessor. However, the spirit and scope of the present technology is not limited to the use of microprocessors for processing information. Indeed, pursuant to one example, central processor 1420 is a processor other than a microprocessor.

Computer system 1400 further includes data storage features such as a computer-usable volatile memory unit 1430, wherein computer-usable volatile memory unit 1430 is coupled with address/data bus 1410 and used to store information and instructions for central processor 1420. In an embodiment, computer-usable volatile memory unit 1430 includes random access memory (RAM), such as static RAM and/or dynamic RAM. Moreover, computer system 1400 also includes a computer-usable non-volatile memory unit 1440 coupled with address/data bus 1410, wherein computer-usable non-volatile memory unit 1440 stores static information and instructions for central processor 1420. In an embodiment, computer-usable non-volatile memory unit 1440 includes read-only memory (ROM), such as programmable ROM, flash memory, erasable programmable ROM (EPROM), and/or electrically erasable programmable ROM (EEPROM). The foregoing notwithstanding, the present technology is not limited to the use of the exemplary storage units discussed herein. Indeed, other types of memory may also be implemented.

With reference still to FIG. 14, computer system 1400 also includes one or more signal generating and receiving devices 1450 coupled with address/data bus 1410 for enabling computer system 1400 to interface with other electronic devices and computer systems. The communication interface(s) implemented by one or more signal generating and receiving devices 1450 may utilize wireline (e.g., serial cables, modems, and network adaptors) and/or wireless (e.g., wireless modems and wireless network adaptors) communication technologies.

In an embodiment, computer system 1400 includes an optional alphanumeric input device 1460 coupled with address/data bus 1410, wherein optional alphanumeric input device 1460 includes alphanumeric and function keys for communicating information and command selections to central processor 1420. Moreover, pursuant to one embodiment, an optional cursor control device 1470 is coupled with address/data bus 1410, wherein optional cursor control device 1470 is used for communicating user input information and command selections to central processor 1420. Consider the example where optional cursor control device 1470 is implemented using a mouse, a track-ball, a track-pad, an optical tracking device, or a touch screen. In a second example, a cursor is directed and/or activated in response to input from optional alphanumeric input device 1460, such as when special keys or key sequence commands are executed. In an alternative embodiment, however, a cursor is directed by other means, such as voice commands.

With reference still to FIG. 14, pursuant to one embodiment, computer system 1400 includes an optional computer-usable data storage device 1480 coupled with address/data bus 1410, wherein optional computer-usable data storage device 1480 is used to store information and/or computer executable instructions. In an example, optional computer-usable data storage device 1480 is a magnetic or optical disk drive, such as a hard drive, floppy diskette, compact disk-ROM (CD-ROM), or digital versatile disk (DVD).

Furthermore, in an embodiment, an optional display device 1490 is coupled with address/data bus 1410, wherein optional display device 1490 is used for displaying video and/or graphics. In one example, optional display device 1490 is a cathode ray tube (CRT), liquid crystal display (LCD), field emission display (FED), plasma display or any other display device suitable for displaying video and/or graphic images and alphanumeric characters recognizable to a user.

Computer system 1400 is presented herein as an exemplary computing environment in accordance with an embodiment. However, computer system 1400 is not strictly limited to being a computer system. For example, an embodiment provides that computer system 1400 represents a type of data processing analysis that may be used in accordance with various embodiments described herein. Moreover, other computing systems may also be implemented. Indeed, the spirit and scope of the present technology is not limited to any single data processing environment.

The above discussion has set forth the operation of various exemplary systems and devices, as well as various embodiments pertaining to exemplary methods of operating such systems and devices. In various embodiments, one or more steps of a method of implementation are carried out by a processor under the control of computer-readable and computer-executable instructions. For example, such instructions may include instructions on a computer-usable medium wherein the instructions when executed cause a computer system to perform a particular method, or step thereof. Thus, in some embodiments, one or more methods are implemented via a computer, such as computer system 1400 of FIG. 14.

In an embodiment, and with reference still to FIG. 14, the computer-readable and computer-executable instructions reside, for example, in data storage features such as computer-usable volatile memory unit 1430, computer-usable non-volatile memory unit 1440, or optional computer-usable data storage device 1480 of computer system 1400. Moreover, the computer-readable and computer-executable instructions, which may reside on computer useable/readable media, are used to control or operate in conjunction with, for example, a data processing unit, such as central processor 1420.

Therefore, one or more operations of various embodiments may be controlled or implemented using computer-executable instructions, such as program modules, being executed by a computer. Generally, program modules include routines, programs, objects, components, data structures, etc., that perform particular tasks or implement particular abstract content types. In addition, the present technology may also be practiced in distributed computing environments where tasks are performed by remote processing devices that are linked through a communications network. In a distributed computing environment, program modules may be located in both local and remote computer-storage media including memory-storage devices.

Although specific steps of exemplary methods of implementation are disclosed herein, these steps are examples of steps that may be performed in accordance with various exemplary embodiments. That is, embodiments disclosed herein are well suited to performing various other steps or variations of the steps recited. Moreover, the steps disclosed herein may be performed in an order different than presented, and not all of the steps are necessarily performed in a particular embodiment.

Although various electronic and software based systems are discussed herein, these systems are merely examples of environments that might be utilized, and are not intended to suggest any limitation as to the scope of use or functionality of the present technology. Neither should such systems be interpreted as having any dependency or relation to any one or combination of components or functions illustrated in the disclosed examples.

Although the subject matter has been described in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. Instructions on a computer-usable medium wherein the instructions when executed cause a computer system to perform a method of formatting information for transmission over a peer-to-peer communication network, said method comprising:
identifying a graphical nature of said information;
capturing said information based on said graphical nature;
identifying a graphical content type associated with said information; and
encoding said information based on said graphical content type.

2. The computer-usable medium of claim 1, wherein said method further comprises:
identifying a plurality of image frames associated with said information;
conducting a motion search configured to identify a difference between said plurality of image frames; and
encoding said information based on a result of said motion search.

3. The computer-usable medium of claim 2, wherein said method further comprises:
identifying a global motion associated with said plurality of image frames; and
biasing said motion search based on said global motion.

4. The computer-usable medium of claim 2, wherein said method further comprises:
displaying a portion of said information in a window of a graphical user interface (GUI);
identifying an interaction with said window; and
biasing said motion search based on said interaction.

5. The computer-usable medium of claim 1, wherein said method further comprises:
identifying an image frame associated with said information; and
encoding portions of said image frame differently based on said portions being associated with different graphical content types.

6. The computer-usable medium of claim 5, wherein said method further comprises:
identifying each of said different graphical content types from among a group of graphical content types consisting essentially of text data, natural image data and synthetic image data.

7. The computer-usable medium of claim 1, wherein said method further comprises:
identifying a request for said information at a point in time;
selecting an image frame associated with said information based on said point in time; and
utilizing an intra-coding compression scheme to compress said image frame in response to said request, wherein said compressed image frame provides a decoding reference for decoding said encoded information.

8. Instructions on a computer-usable medium wherein the instructions when executed cause a computer system to perform a method of formatting information for transmission over a peer-to-peer communication network, said method comprising:
identifying a graphical nature of said information;
capturing said information based on said graphical nature;
identifying a graphical content type associated with said information;
identifying a data processing load associated with a central processing unit (CPU); and
encoding said information based on said graphical content type and said data processing load.

9. The computer-usable medium of claim 8, wherein said method further comprises:
identifying a current data processing capacity associated with said CPU based on said data processing load; and
allocating portions of said current data processing capacity to different simultaneous sharing sessions such that data sharing qualities associated with said different simultaneous sharing sessions are substantially similar.

10. The computer-usable medium of claim 8, wherein said method further comprises:
identifying image frames associated with said information;
partitioning said image frames into a plurality of macroblocks;
identifying matching macroblocks from among said plurality of macroblocks based on said matching macroblocks being substantially similar, wherein said matching macroblocks are associated with different image frames;
identifying a variation between said matching macroblocks; and
encoding said information based on said variation.

11. The computer-usable medium of claim 10, wherein said method further comprises:
subdividing each of said plurality of macroblocks into smaller data blocks according to a partitioning mode;
identifying corresponding data blocks from among said smaller data blocks; and
identifying said variation based on a distinction between said corresponding data blocks.

12. The computer-usable medium of claim 11, wherein said method further comprises:
adjusting said partitioning mode based on said data processing load.

13. The computer-usable medium of claim 10, wherein said method further comprises:
accessing a search range parameter that defines a range of searchable pixels and a search accuracy parameter that defines a level of sub-pixel search precision;
identifying said matching macroblocks based on said search range parameter, wherein said matching macroblocks are located in different relative frame locations;
defining a motion vector associated with said matching macroblocks based on said search accuracy parameter; and
encoding said information based on said motion vector.

14. The computer-usable medium of claim 13, wherein said method further comprises:
adjusting said search range parameter based on said data processing load.

15. The computer-usable medium of claim 13, wherein said method further comprises:
selecting said search accuracy parameter from a group of search accuracy parameters consisting essentially of an integer value, a half value and a quarter value.

16. The computer-usable medium of claim 13, wherein said method further comprises:
adjusting said search accuracy parameter based on said data processing load.

17. Instructions on a computer-usable medium wherein the instructions when executed cause a computer system to perform a method of formatting information for transmission over a peer-to-peer communication network, said information being associated with a displayed application, and said method comprising:
identifying said information in response to a selection of said application;
identifying a media type associated with a portion of said information;
capturing said portion based on said media type;
identifying a content type associated with said portion; and
encoding said portion based on said content type.

18. The computer-usable medium of claim 17, wherein said method further comprises:
determining said media type to be a graphical media type; and
capturing said portion based on said graphical media type.

19. The computer-usable medium of claim 17, wherein said method further comprises:
determining said media type to be an audio media type; and
capturing said portion based on said audio media type.

20. The computer-usable medium of claim 17, wherein said method further comprises:
identifying a different media type associated with another portion of said information;
capturing said another portion based on said different media type;
identifying a different content type associated with said another portion; and
encoding said another portion based on said different content type.

21. Instructions on a computer-usable medium wherein the instructions when executed cause a computer system to perform a method of formatting information for transmission over a peer-to-peer communication network, said method comprising:
identifying a media type associated with said information;
capturing said information based on said media type;
identifying a content type associated with said information;
identifying a transmission rate that is sustainable over said peer-to-peer communication network;
selecting a target rate based on said transmission rate; and
encoding said information based on said content type and said target rate.

22. The computer-usable medium of claim 21, wherein said method further comprises:
packetizing said encoded information to create a data stream configured for transmission over said peer-to-peer communication network;
allocating a portion of said target rate as an error correction bandwidth based on an error resilience scheme associated with said peer-to-peer communication network;
generating a packet set of error correction packets based on said error correction bandwidth; and
adding said packet set of error correction packets to said data stream.

23. The computer-usable medium of claim 21, wherein said method further comprises:
configuring a rate distortion function based on said target rate; and
implementing said rate distortion function such that data sharing qualities associated with different simultaneous sharing sessions are substantially similar.

24. Instructions on a computer-usable medium wherein the instructions when executed cause a computer system to perform a method of encoding graphical information, said method comprising:
encoding a portion of said graphical information based on an encoding setting;
packetizing said encoded portion to create a plurality of data packets;
receiving feedback indicating a transmission loss of a data packet from among said plurality of data packets;
dynamically adjusting said encoding setting in response to said transmission loss; and
encoding another portion of said graphical information in accordance with said adjusted encoding setting such that a transmission error-resilience associated with said graphical information is increased.

25. The computer-usable medium of claim 24, wherein said method further comprises:
selecting said encoding setting based on an encoding prediction format;
dynamically adjusting said encoding prediction format in response to said transmission loss; and
altering said encoding setting based on said adjusted encoding prediction format.

26. The computer-usable medium of claim 24, wherein said method further comprises:
varying a number of video descriptions pertaining to said graphical information in response to said transmission loss; and
modifying said encoding setting based on said varied number of video descriptions.

27. The computer-usable medium of claim 24, wherein said method further comprises:
selecting a number of image frames associated with said graphical information as reference frames based on a referencing frequency parameter;
identifying other image frames associated with said graphical information as predicted frames;
partitioning said reference frames and said predicted frames into a number of slice partitions in accordance with a slice partitioning parameter; and
selecting said encoding setting based on a difference between slice partitions of said reference frames and slice partitions of said predicted frames.

28. The computer-usable medium of claim 27, wherein said method further comprises:
dynamically adjusting said referencing frequency parameter in response to said transmission loss; and
modifying said encoding setting based on said adjusted frequency parameter.

29. The computer-usable medium of claim 27, wherein said method further comprises:
dynamically adjusting said slice partitioning parameter in response to said transmission loss; and
modifying said encoding setting based on said adjusted slice partitioning parameter.
